(19) United States
(12) Patent Application Publication
(10) Pub. No.: US 2015/0187011 A1
(43) Pub. Date: Jul. 2, 2015

(54) COMPUTERIZED SYSTEM AND METHOD OF EVALUATING INSURANCE PRODUCT UNDERWRITING AND RATING DATA

(71) Applicant: SYNTEL, INC., Troy, MI (US)

(72) Inventors: DEEPAK PURANDARE, Pune (IN); PRIYA PADMANABHAN LAKSHMANAN, Chennai (IN)

(21) Appl. No.: 14/141,622

(22) Filed: Dec. 27, 2013

(51) Int. Cl. G06Q 40/08

(52) U.S. Cl. CPC G06Q 40/08

(57) ABSTRACT

A systems, method, and computer program product for evaluating an insurance policy underwriting and rating instance is disclosed. The system may include a lexer module on a computer, a parser module on a computer, and a generator module on a computer. The lexer module may be configured to tokenize the insurance policy instance. The parser module may be configured to parse the tokenized insurance policy instance. The generator module may be configured to receive a profile associated with an insured person; and evaluate the insurance policy instance by applying the profile to the insurance policy instance.

### TECHNICAL FIELD

The present disclosure relates to computerized systems, and, in particular, this disclosure relates to a computerized system programmed with a tool for evaluating underwriting and rating data.

### BACKGROUND AND SUMMARY

Underwriting and rating are integral processes in determining of what one may pay for various types of insurance (e.g., homeowners, automobile, and the like). For example, as used in policy administration systems, these processes analyze characteristics of an individual and determine a risk the individual may present. These processes use insurance product definitions and algorithms to perform this analysis. The algorithms (i.e., instances) describe in detail how to combine the various components in rules and rate pages to calculate the overall premium charged for any risk. The algorithms may give explicit instructions including but not limited to: the order in which rating variables should be considered, how the effect of rating variables is applied in the calculation of premium (e.g., multiplicative, additive, or some unique mathematical expression), and the existence of maximum and minimum premiums. Simply put, these algorithms may determine an individual's insurance details for a given type of insurance based on the product offered by an insurance provider.

Typically, business users (e.g., providers, actuaries, agents, and the like) use spreadsheets to define underwriting and rating algorithms. Despite this popularity, the use of spreadsheets for this purpose can pose significant problems. For example, when working with spreadsheets, many macros may need to be developed, which can be cumbersome to test and validate. Also, verification of rating algorithms that are defined in a spreadsheet is difficult, if not impossible, to perform. Further, defining complex business rules is difficult, and, consequently, only the creator of a particular rating algorithm of an insurance product may be able to understand the underlying logic and inner workings of the algorithms, making maintenance and roll-out of a new insurance product a time consuming and potentially expensive undertaking.

As such, there is a need for a language to define insurance underwriting and rating algorithms (i.e. instances) in a simplified manner so that any business user (e.g., actuary, broker, underwriter, and the like) will be able to understand and maintain effectively. There is also a need for a tool to test and verify the underwriting and rating instances, such as those defined by this new language. For example, accuracy and correctness could be validated prior to, and upon, actual implementation of new underwriting and rating algorithms of a new product in a policy administration system.

According to one aspect, this disclosure provides systems, methods, and computer program products for evaluating an insurance policy underwriting and rating instance. Embodiments of the disclosure may include a lexer module on a computer, a parser module on a computer, and a generator module on a computer. The lexer module may be configured to tokenize the insurance policy underwriting and rating instance. The parser module may be configured to parse the tokenized insurance policy instance. The generator module may be configured to receive a profile associated with an insured person; and evaluate the insurance policy instance by applying the profile to the insurance policy instance.

Optionally, the generator module may be configured to graphically display a result of the evaluation. The result may include a simulated premium to be paid by the insured person. The result may be compared to a second result generated by the application of the insurance policy instance implemented in a policy administration system. The insurance policy underwriting instance may be defined in a top-down sequence, and may use at least one parameter configured to retrieve data from a multi-dimensional array.

Additional features and advantages of the invention will become apparent to those skilled in the art upon consideration of the following detailed description of the illustrated embodiment exemplifying the best mode of carrying out the invention as presently perceived.

### BRIEF DESCRIPTION OF DRAWINGS

The present disclosure will be described hereafter with reference to the attached drawings which are given as non-limiting examples only, in which:

FIG. 1A is a diagrammatical view of a model illustrating a calculation for a premium for personal auto-bodily injury coverage;

FIG. 1B is sample text of the underwriting and rating language definition according to one embodiment of the present disclosure;

FIG. 2 is a diagrammatical view of an example computing device that may be included in the evaluation tool and that may be programmed to carry out various methods taught herein according to one embodiment of the disclosure;

FIG. 3 is a high level diagrammatical view of the evaluation tool according to one embodiment of the disclosure;

FIG. 4 is a simplified illustration of components of the evaluation tool according to one embodiment of the disclosure;

FIG. 5 is an illustration of an example of how the evaluation tool can be used to validate a new insurance product prior to, or upon, actual implementation in a policy administration system;

FIG. 6 is an illustration of an example screenshot of a main page of the evaluation tool according to one embodiment of the disclosure;

FIG. 7 is an example screenshot of the console according to one embodiment of the disclosure;

FIG. 8 is an example screenshot of an input upon clicking the input tab according to one embodiment of the disclosure;

FIG. 9 is an example screenshot of an output upon clicking the output tab according to one embodiment of the disclosure;

FIG. 10 is an example screenshot of an abstract syntax tree upon clicking the abstract syntax tree tab according to one embodiment of the disclosure;

FIG. 11 is a text example of an underwriting and rating instance for determining bodily injury coverage for a potentially insured individual's personal vehicle in accordance with the model of FIG. 1, according to one embodiment of the disclosure;

FIGS. 12A and 12B are screenshots of example input tables providing details about insured individual's personal vehicle and driving details according to one embodiment of the disclosure;

FIG. 13 is an example screenshot of an increased limits factor table according to one embodiment of the disclosure;

FIG. 14 is an example screenshot of a female_noyouthful_operator table according to one embodiment of the disclosure;

FIG. 15 is an example screenshot of a state rules table according to one embodiment of the disclosure; and

FIG. 16 is an example screenshot of an output generated by the evaluator tool according to one embodiment of the disclosure.

Corresponding reference characters indicate corresponding parts throughout the several views. The exemplification set out herein illustrates embodiments of the invention, and such exemplification is not to be construed as limiting the scope of the invention in any manner.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the disclosure.

Embodiments of the present disclosure include an underwriting and rating language that allows a user to assemble business rules, business logic, and expressions in a manner that is readable, easy to understand and intuitive to the user. The evaluation tool allows a user to configure underwriting and rating algorithms, and evaluate the same given a set of inputs (e.g., characteristics of potentially insured individuals or prospective insurance buyers with respect to the insurance product of interest).

### Underwriting and Rating Language

Embodiments of the present disclosure include numerous features for expressing programming logic and algorithms. These features include, but are not limited to defining business rules, arithmetic expressions, data types, mixed mode operations, data type promotions, type casting and coercion, functions, special constructs, and in sequence/ out of sequence operations.

An example rater instance is shown below:

| /* | |
|---|---|
| * | Sample rater |
| */ | |

Task Name: “First program”
Input: a = 100; b = 20; c = 10;
Output: x; y; z; p; q; r;
Processing Unit:
Type: In Sequence

| | |
|---|---|
| x = y + c; | //unit type is in sequence, this will not |

be

//calculated

y = z + b;
z = a + b;

End Unit
Processing Unit: Type: Out of sequence
...statements...
End Unit

### Task Definition

Each instance may be defined as a task. An instance begins with defining the “Task Name,” which may be any identifier string by which a user wishes to identify the instance. The task may take an input defined in the “Input” clause, and perform the operation defined in any processing units in sequential order. The task will then fill in values for the parameters specified in the “Output” clause.

### Specifying Input and Output

Embodiments of the disclosure allow for the initialization of some parameters to values. Embodiments may use these initialized values while performing the actions specified in the processing units. The language performs run time data type identification when the input parameters are initialized. It should be noted that it is not required for parameters to be initialized with values. When a parameter is not initialized with a value, the language assumes the user knows the origin of the values for the parameters and their appropriate data type. The data type may be assigned to the parameters at the time of first assignment of value. The results of processing may be found as specified in the designated “output” clause.

### Processing Units

Each task can have multiple processing units. Each processing unit may have a unit type which is either “In Sequence” or “Out of sequence.” “In sequence” units process the statements from first to last and will exit irrespective of if there is any expression that is not processed due to lack of parameter values. Alternatively “Out of sequence” units will process the unit from first statement to last and check how many statements are evaluated properly. Absence of value of any parameter will cause failure. In case there are still some statements that are not evaluated satisfactorily, the tool reiterates with the newly calculated values in an attempt to identify any additional statements that can now be satisfied. The language assumes the presence of backtracking or iterative fulfillment of parameter values. An example of a minimal rating algorithm (i.e., instance) is shown below:

```
// Sample program
Task Name: “First program”
Input: a = 100; b = 20; c = 10;
Output: x; y; z; p; q; r;
Processing Unit: Type: In Sequence
      x = y + c;
      y = z + b;
      z = a + b;
End Unit
Processing Unit: Type: Out of sequence
      p = q + c;
      q = r + b;
      r = a + b;
End Unit
```

When this instance is run, the following output is displayed:

| | Data | |
|---|---|---|
| Parameter | Type | Value |
| x | Unknown | |
| y | Unknown | |
| z | Integer | 120 |
| p | Integer | 150 |
| q | Integer | 140 |
| r | Integer | 120 |

As illustrated by the example instance, because x and y cannot be resolved in a first iteration in top down order, they were ignored. However, values of p and q were indeed calculated.

An example showing the use of string operations is shown below. As shown, two strings are added into a third.

/*
* Handling the string operation...
*/
Task Name:“Hello world!”
Input: hello = “Hello” ; world = “world!”;
Output: message;
Processing Unit:
Type: In Sequence
message = hello + “ ” + world;
End Unit

This will produce the following output:

| Parameter | Data Type | Value |
|---|---|---|
| message | String | Hello world! |

### Statements

Statements may take the form of assignments, arithmetic expressions, and business rules. Statements can also be used to fetch parameter values from multi-dimensional arrays (“MDA”), databases, and the like.

### Comments

Comments may be block comments or in-line comments. The tool allows for comments to be written in a fashion similar to that of the C++ programming language. For example, and as shown below, inline comments may start with “//” and continue until the end of the line:

// This is a comment
// This is another comment.

Another example is shown below:

Input:

State = “AL”; // currently available for AL, NY,

OH

Garagingloc_ZipCode = 35620; // 5 digit zip code

// for garaging location

Primary_UseOf_Vehicle = “Drive to work”;

// This could be:
// Drive to work
// Farm use
// Domestic use

Block comments may be defined as shown in the following example:

/*
* Auto Underwriting including state specific rules
* Created By: XYZ
* Version: 1.3
*/

### Data Types

Embodiments of the present disclosure allow for defining parameters with the following data types:
Integer
Float
Date
Character
String
Boolean
Currency

Other primitive data types that typically appear in other programming languages such as short, long, double may also be implemented. Depending on the need, may take the form of other suitable types already defined by embodiments of the present disclosure. During runtime, the types are identified based on the value contents. Some examples of the types in use are as follows:

// Integer
ID = 101;
NoOfVehicle = 2;
// Float
RateOfInterest = 7.5;
MultFactor = 0.95;
// Integer and Float are differentiated by use of
decimal point.
// Date
DOB = ″02-10-1965″; // this should be in MM-DD-YYYY
form
// Character
IsABSAVailable = ‘Y’; // look at the single quotes
// String
PrimaryUse = ″Farm use″; // look at the double quotes
// Boolean
isTrainingDone = true; //Boolean vales is “true” or
″false″
// When true or false is given in quotes, the data
type becomes
// String and not Boolean. Please remember this.
// Currency
coPay = $ 100.0 // decimal point is needed.
// At runtime, currency parameters can be translated
to float for simplicity.

### Mixed Mode Operations and Data Type Promotions

Oftentimes during evaluation of arithmetic expressions, parameters of various data types may be employed. As such, embodiments of the present disclosure allow for implementation of rules to work with mixed mode types. Below is an example instance using these different data types and modes:

Task Name: “Mixed mode operations”
Input: a = 100; b = 19.9; c = “12-21-2012”;

d = 16; str = “Value = ”;
flag = true; amount = $ 15.5;

Output: p; q; r; s; t; u; w; x; y; z; m;
Processing Unit:
Type: In Sequence

| | |
|---|---|
| p = a / b; | // Integer / Float −> Float |

| | |
|---|---|
| q = b / a; | // Float / Integer −> Float |
| r = a / d; | // Integer / Integer −> |

Integer

| | |
|---|---|
| s = str + r; | // String + Integer −> String |

| | |
|---|---|
| t = c + a; | // Date + Integer −> Date |
| u = a + c; | // Integer + Date −> Date |

| | |
|---|---|
| w = r + str; | // Integer + String −> Unknown |

| | |
|---|---|
| x = c − b; | // Date + Float −> |

Date

// here b − c will result in the

same.

| | |
|---|---|
| y = b + c; | // Float + Date −> |

Date

| | |
|---|---|
| z= flag + a; | // Boolean + any −> |

Unknown

| | |
|---|---|
| m = amount + a; | // Currency + Integer −> |

Float
End Unit

This instance results in the following output:

| Parameter | Data Type | Value |
|---|---|---|
| p | Float | 5.0251255 |
| q | Float | 0.199 |
| r | Integer | 6 |
| s | String | Value = 6 |
| t | Date | Sun Mar 31 00:00:00 IST 2013 |
| u | Date | Sun Mar 31 00:00:00 IST 2013 |
| w | Unknown | |
| x | Date | Sun Dec 02 00:00:00 IST 2012 |
| y | Date | Wed Jan 09 00:00:00 IST 2013 |
| z | Unknown | |
| m | Float | 115.5 |

As shown above, embodiments of the disclosure allow for the operation on parameters of different types. For example, and as shown, “a” is defined as an integer, and “b” is defined as a floating point. The output “p,” defined by the expression “a/b”, is calculated to be a floating point “5.0251255”. As another example, and shown above, the addition of an integer or floating point, and a date parameter causes the date to be increment or decrement by the number of days equivalent to the integer value of the parameter.

### Statements

Embodiments of the present disclosure allow for statements of the following types:
Assignments
Arithmetic expressions
Business Rules
CalculateWithRule
Getting data from external source
   GetFromMDA
   GetFromMDAWithRule
GetWithQuery

### Assignment Statements and Arithmetic Expressions

An assignment refers to the assigning of a value to a parameter or to the result of the evaluation of an arithmetic expression to a parameter. Some examples are as follows:

DistanceTravelledinKM=SpeedinKMPH*TimeinHR;

SimpleInterest=Principle*InterestRate*Time;

Supported operations include, but are not limited to:
Addition, Subtraction: +, −
Multiplication, Division: *, /
Unary +, −

### Business Rules

Business rules may be defined in the following manner:

Business Rule:

if (Boolean Expression)
{

Statements;

| } | |
|---|---|
| elseif (Boolean Expression) | // This block can repeat |
| { | // |

| | |
|---|---|
| Statements; | // |

| | |
|---|---|
| } | // |

else {

Statements;

}

### End Rule;

The Boolean expression may be a combination of relational and logical expressions. For example:

(Relational Expression)(<Logical Operator>(Relational Expression))*

The syntax and semantics of the above expressions may be similar to any other high level languages such as C, C++, and Java. The operators used are the same as that in these languages as well. Available operators include, but are not limited to the following:

== != < <= > >=

Logical operators include, but are not limited to the following:
&& ∥ !

The logical operator “!” may be used as a unary operator and may negate the result of an expression as shown in the following example:

Business Rule :
if ((State != “DE” ) && (DefensiveDrivingCourse == true))
{

Factor = 0.95;
if ((State == “MN”) || (State == “NY”)){

Factor = 0.93;

}
elseif ((State == “IL”) && (Coverage_Amount<

100000.0)) {

Factor = 0.93;

}
else {

Factor = 1.0;

}

}
elseif ((State == “MN”) || (State == “NY”))

Factor = 0.93;

elseif ((State == “IL”) && (Coverage_Amount>100000.0))

Factor = 0.95;

else {

Factor = 1.0;

}

End Rule;

According to embodiments of the disclosure, statements may take the form of assignment statements with arithmetic expressions, or “GetWithQuery” statements. However, it should be noted that embodiments are not so limited, and that statements may take other forms as well.

A “GetWithQuery” statement can be used within a business rule and may be employed to optimize the data fetching operations, which typically can be time consuming. An example of this use is shown below:

Business Rule:
if((State != “CA”)&&( State != “GA”))
{

P1TBCLC = 101;
GetWithQuery( “Select Territory_Code from

TerritoryCode where
Garagingloc_ZipCode = ?”;

Input: Garagingloc_ZipCode;
Output: Territory_Code);

}

}

End Rule;

As can be seen from the above example, the territory code is fetched only when the state is not CA and GA. It is also important to note that nesting is possible to any level, and that an “elseif” clause can be repeated multiple times.

### Special Constructs

Embodiments of the present disclosure allow for the creation of special constructs that are built to abstract logic. These special constructs include but are not limited to:
CalculateWithRule
GetFromMDA
MDAWithRule

It should be noted that an entire rating instance may be defined without using any of these special constructs. However, their use may serve to give proper structure and meaning to the assembly of expressions.

### CalculateWithRule

The syntax of this construct can be expressed as follows:

<ParamName> = CalculateWithRule (Expression ;
<Business Rule>
(Statement ;)*
);

Referring to the above example, “ParamName” may be valid parameter, and “Expression” may be any valid arithmetic expression. Another example of the use of “CalculateWithRule” is as follows:

FinalPayment = CalculateWithRule (Principle * InterestRate

* Duration;

Business Rule:
if ((Taxable = true) && (TaxDedSource = true) && (Waiver

| | |
|---|---|
| ==0) ) | { |

deduction = Principal * InterestRate * Duration * 0.3;

}
else {

deduction = 0;

}
End Rule
FinalPayment = FinalPayment − deduction;

) ;

As can be seen from the example immediately above, the “CalculateWithRule” construct may help encapsulate the processing logic to a unit level. It should be noted that the same result could be achieved without using this construct. However, use of the construct may help in grouping together logically related operations.

### GetFromMDA

The “GetFromMDA” construct may be used to get information from external sources (e.g., MDAs). With multiple parameters, there could be unique tuples. Searching for a value of a parameter when values of other parameters are known is possible by forming a query. This concept may form the basis for relational data representation (e.g., every row is unique in a table) as used herein. For example, “GetFromMDA” may have the following syntax:
<Param>=GetFromMDA(Input: <Param>(, Param)*; Output: <Param>; Source: Object=<“source name”>);

As can be seen above, “Param” at the left side of “=” is the parameter assigned to the value of the search. Also, there could be one or more commas separating “Input” and “Params”. The Output Parameter is the parameter that may need to be searched for in the MDA. It should be noted that the name of the Output parameter and that on the left side need not be the same. Further, “source name” as shown above, is the name of the table that has all the data.

Another example is as follows:
P1DT=GetFromMDA(Input: State, Is_ABS_Installed; Output: Discount_Factor; Source: Object=“ABS_Discounts”);

Here, “Discount_Factor” is searched for the given “State” and “Is_ABS_Installed” in the table. “ABS_Discounts” and the result is assigned to parameter “P1DT.GetFromMDA.” This may be a simple way to access lookups, if a user needs to access the information conditionally or in the case the user needs complex structured query language (“SQL”) queries to be formed.

### GetFromMDAWithRule

The syntax for “GetFromMDAWithRule” is as follows:

<ParamName> = GetFromMDAWithRule (
Input: <Param> (, Param)*;
Output: <Param>;
<Business Rule>
(Statement ;)*

);

As in this example above, “ParamName” is assigned the value of the overall evaluation. Processing occurs in the following sequence:
1. Value is fetched from MDA as that in “GetFromMDA” using “Input” parameters into “OutputParam” and assigned to the “ParamName” (parameter on left side of assignment)
2. “Business Rule” is evaluated, and then may set some values in parameters
3. The Statement block is evaluated

An example is as follows:

PropertyDamage2 = GetFromMDAWithRule (
Input: SSN, DOB, Gender;
Output: PropertyDamage ;
Source: Object=“input”;

Business Rule :

if ((State == “DE” ) && (DefensiveDrivingCourse

== false) )

{

Factor1 = 0.9;

}
elseif ((State == “MN”) || (State == “IL”))

Factor1 = 0.93;

else {

Factor1 = 1.0;

}

End Rule
PropertyDamage2 = PropertyDamage2 * Factor1;

) ;

The above example instance could be used to modify the value coming from an MDA using rules before it is used in any other expressions. The same result may be achieved using a combination of an assignment “GetFromMDA”, a business rule, and a set of statements. It should be noted that the “GetFromMDAWithRule” construct is primarily defined in order to group various constructs to provide structure.

When using the special constructs such as “GetFromMDA”, “GetFromMDAWithRule”, and “GetWithQuery”, it may be necessary to define the source information, the syntax of which is provided below:

Task Name: <Task Name>
Input : <Input params>
Output : <Output params>
Default Source: database,
ConnectString=“jdbc:odbc:raterinput”, User = “username”,
PWD = “Password”, Driver=“sun.jdbc.odbc.JdbcOdbcDriver”;

A user may also be allowed to use a Java-based database connectivity (“JDBC”) such as that offered from Oracle™ Corporation of Redwood City, Calif.

An example for getting data from “MySQL” is as follows:

Default Source: database,

Connect String=

“jdbc:mysql://localhost/dsp?user=root&password=ds

p101”,
Driver=“com.mysql.jdbc.Driver”,
Input = “Sample”;

As shown above, “Sample” is the name of the input table. Multiple inputs may be provided in an input table. The input parameter names should match the column names of the input table. During processing, each row in the input table is fetched and processed against the instance, and the output is produced corresponding to the input. In the absence of an input table, the input specified in the input clause in the instance (not in the default source) is processed.

Getting Parameter Values from Database: Free Form SQL Queries

There are cases when the simple construct “GetFromMDA” may be limiting. In such cases, it may be necessary to form complex queries to fetch the values from a database. “GetWithQuery” may help where the “GetFromMDA” may have a limitation of getting a value for only one parameter. For example, the “GetWithQuery” may allow the use of parametric queries, and the output could be multiple parameters. When the queries result into multiple rows, the first row is used as a value row and the remaining rows are ignored. The syntax for GetWithQuery is as follows:

GetWithQuery( “<Parameterized Query” ;

Input: <Param> (, Param) * ;
Output: <Param> (, Param) *

);

An example of the use of the “GetWithQuery” construct is shown below:

GetWithQuery(“Select_Company_Loss_Cost_Multiplier from
Carrier_Costs”+

“where State = ? and ” +
“Min_Territory_Code<= ?and” +
“Max_Territory_Code>= ?andCoverage_Name = ?” ;

Input: State, Territory_Code, Territory_Code,

Coverage_Name;

Output: P1CLCM

);

In the above example, the query string is formed as a concatenation of multiple strings (this operation happens as any other high level programming languages those support such concatenation). The “?” indicates the parameters values to be passed during execution. These values are taken from the input and may appear in the same sequence as that in the query question marks. The names provided as output parameters need not be same. In this example, “Company_Loss_Cost_Multiplier” is a name of table column and the fetched value is assigned to “P1CLCM” as a result. A user may choose to have a parameter named “Company_Loss_Cost_Multiplier” in his or her instance for simplicity.

As discussed above, there may be situations when bottom up representation of the expressions does not give clear idea of what is happening and what is expected in those expressions. Consequently, users may have difficulty understanding expressions in this context. Users may need to understand the whole before getting a top level view.

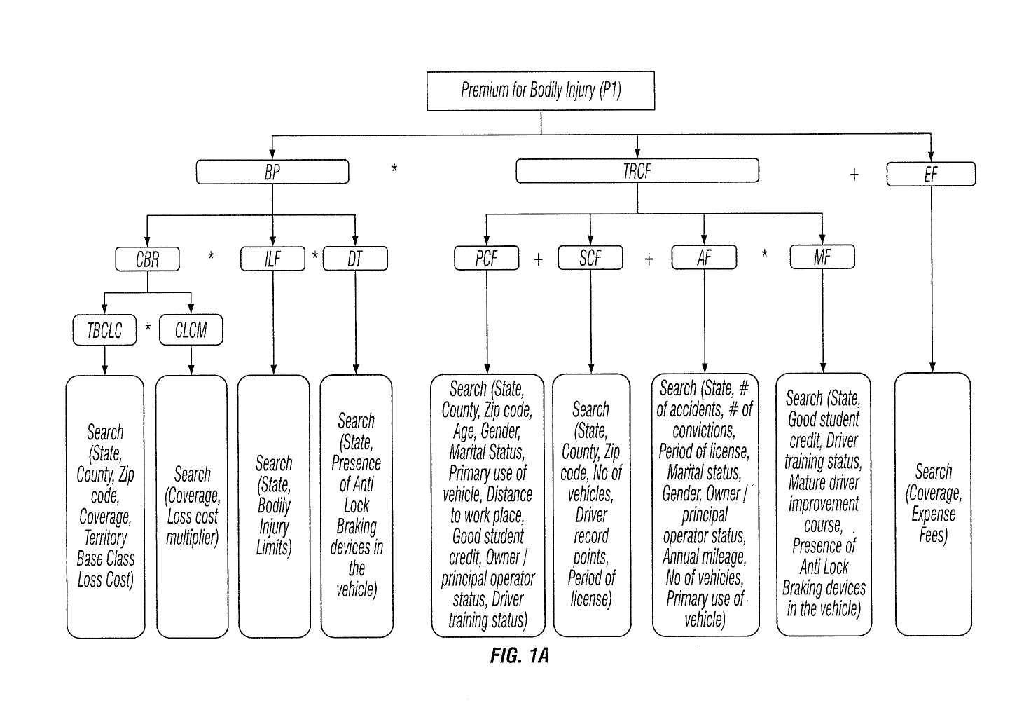

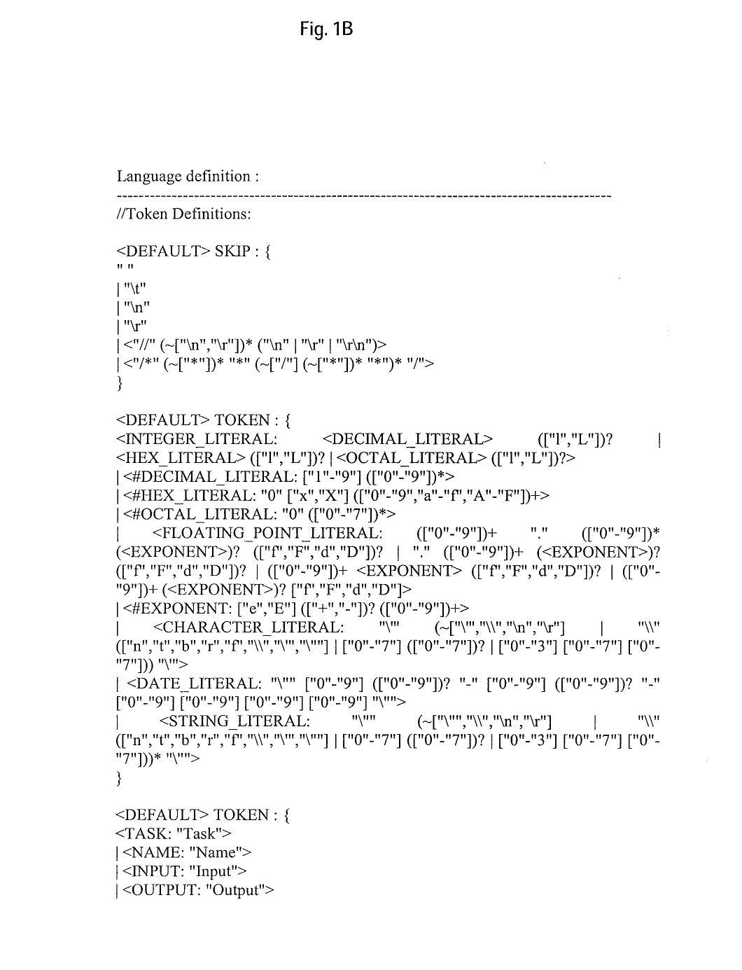

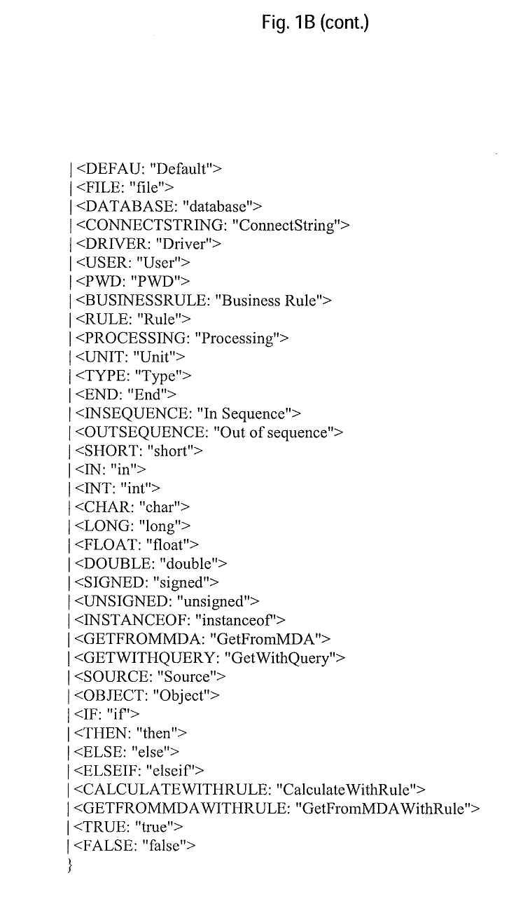

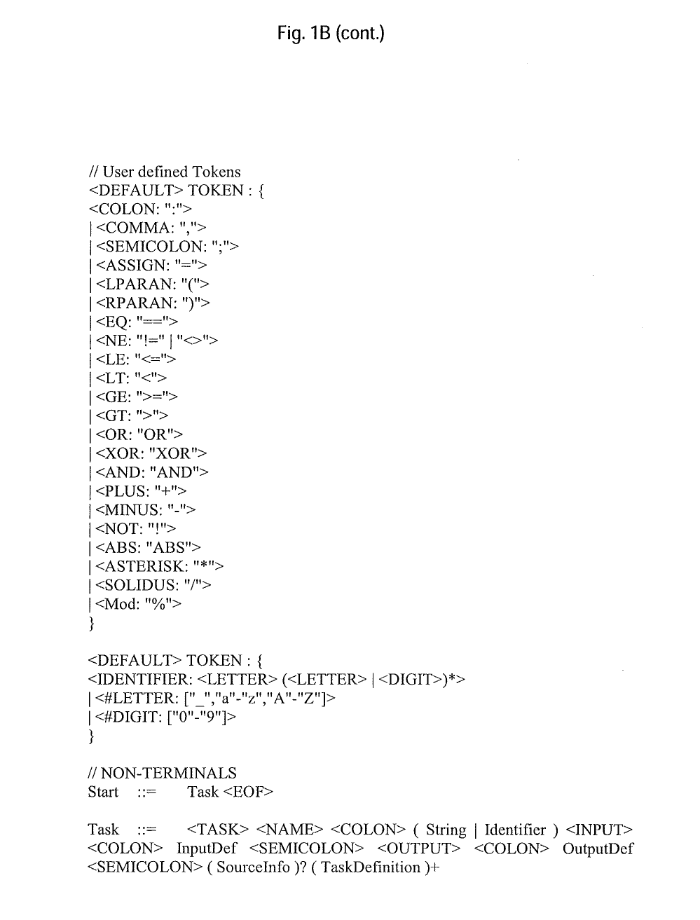

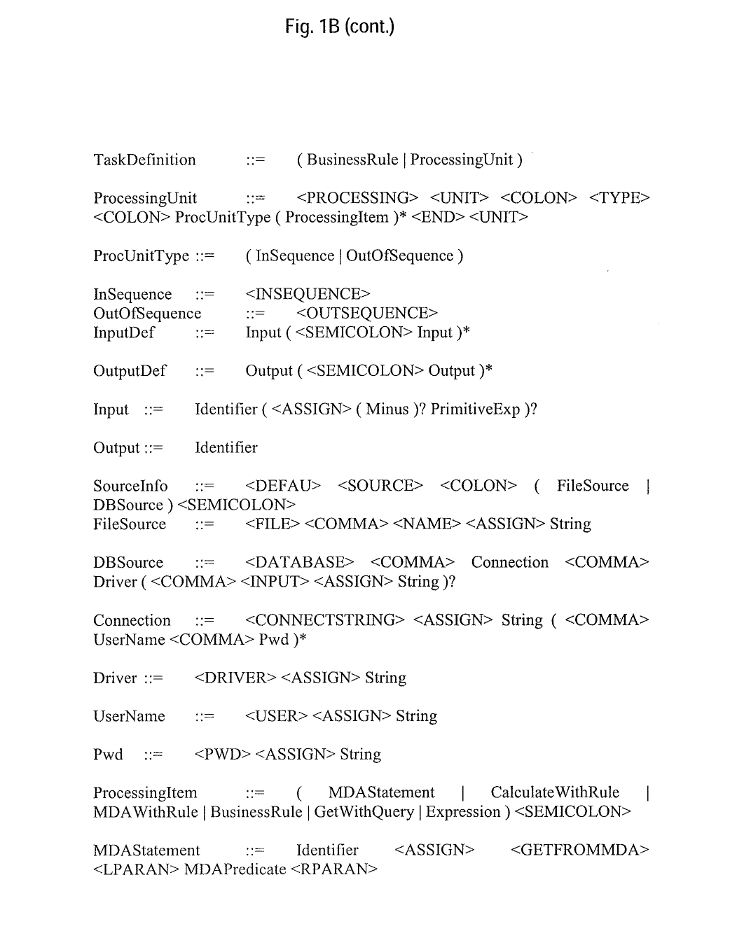

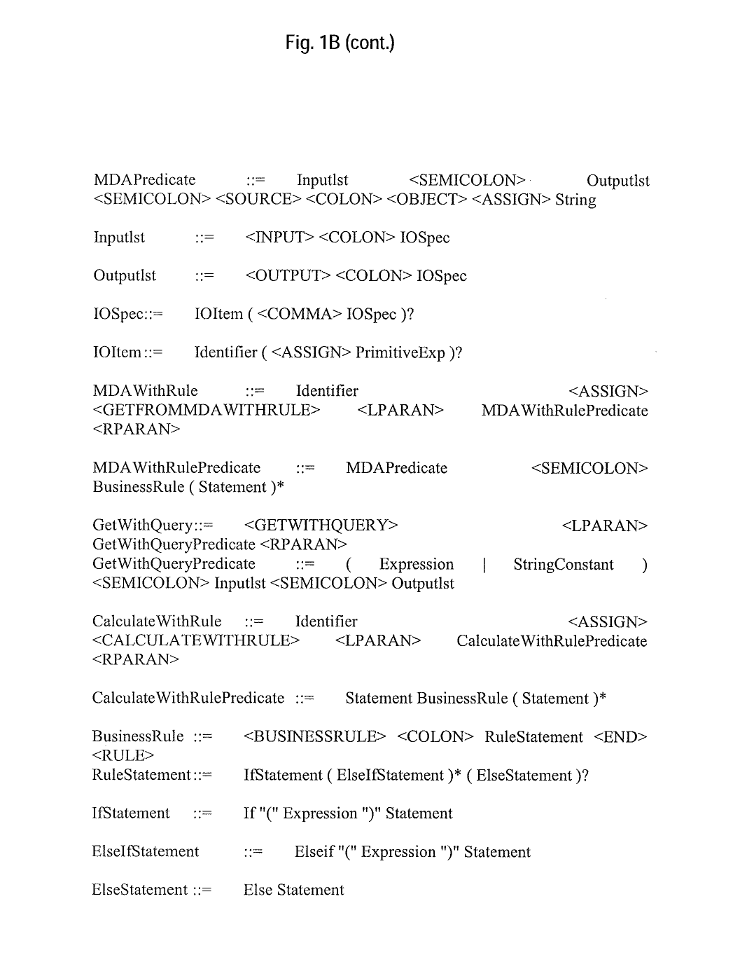

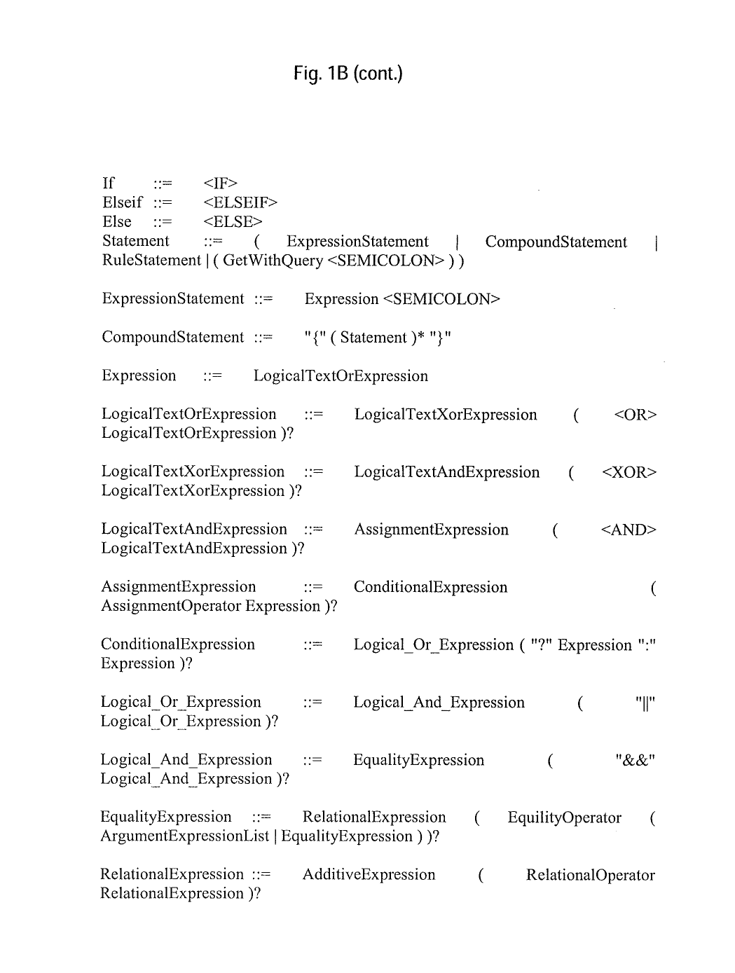

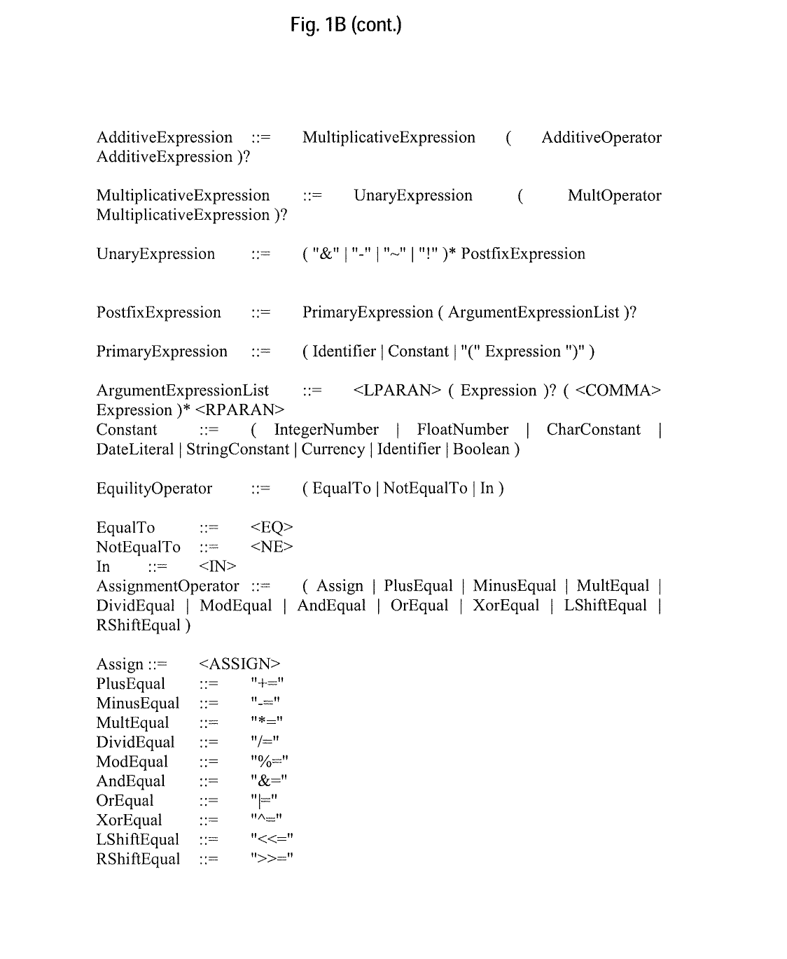

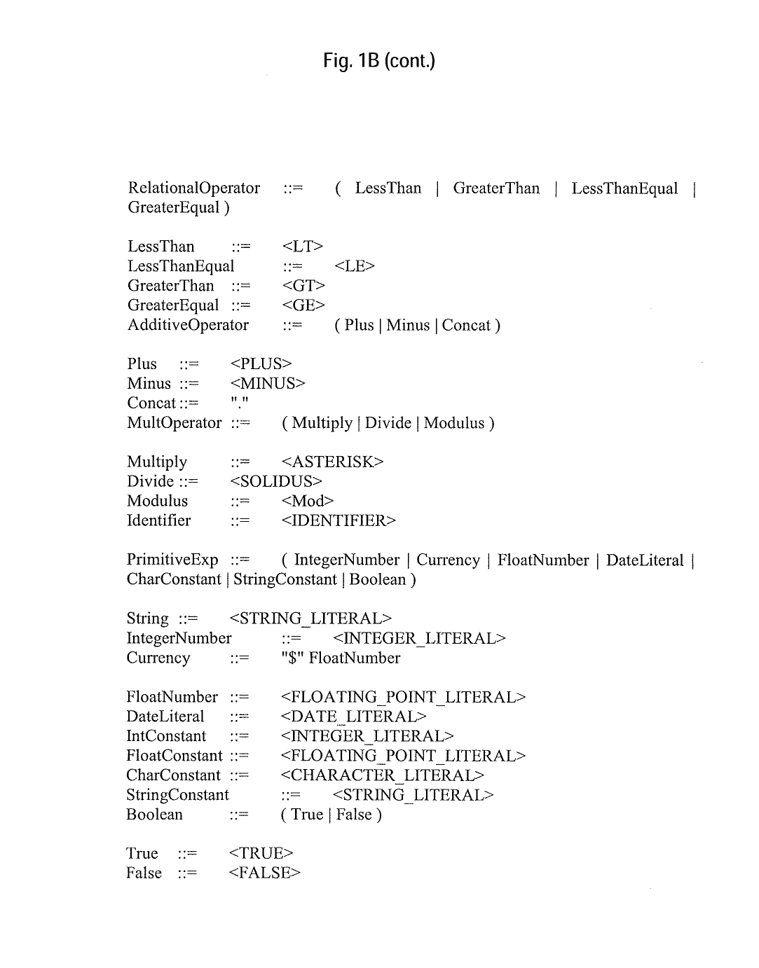

From a user's point of view, a top down representation of a rating instance may be a cleaner way to understand and maintain. However, most programming languages do not support a top down representation. FIG. 1A is a model illustrating a calculation for a premium for bodily injury. One may represent this model in a bottom-up fashion as:

Search(TBCLC)

Search(CLCM)

CBR=TBCLC*CLCM

Search(ILF)

Search(DT)

BP=CBR*ILF*DT

. . .

The above expression will fail unless all parameters used in any of the expressions have a value that can be evaluated. As such, the order is extremely important when constructing a bottom-up instance. Further, the above representation may not give a user a clear idea of what is happening in the construct. Alternatively, using the language as discussed herein, the same construct could be represented in a bottom-up fashion as follows:

BodilyInjuryPremium=BP*TRCF*EF;

BP=CBR*ILF*DT;

CBR=TBCLC*CLCM;

TRCF=PCF*SCF*AF*MF;

// Now time to search values of params

Search( . . . );

. . .

The above representation may be easier for a user to read and understand, especially when instances are large and complex. Further, this construct does not enforce the order in which the expressions should be arranged, which may be particularly useful when the constructs are fetched from different sources by different users.

FIG. 1B is sample text of the afore-discussed language, which follows an Extended Backus-Naur Form (“EBNF”) syntax.

### Evaluation Tool

Embodiments of the present disclosure also include a tool to test and verify underwriting and rating algorithms (e.g., instances), such as those defined by the above-described language. The evaluation tool may be particularly useful to check the accuracy and correctness of a new insurance product's instances prior to actual implementation of the new insurance product in a policy administration system.

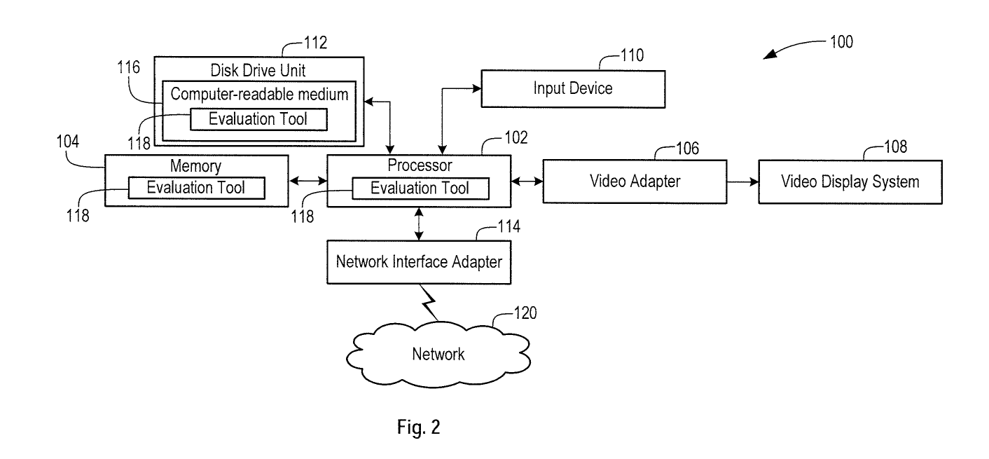

FIG. 2 illustrates a diagrammatic representation of a machine 100, in the example form of a computer system, that may be programmed with a set of instructions to perform any one or more of the methods discussed herein. The machine may be a personal computer, a notebook computer, a server, a tablet computer, a personal digital assistant (“PDA”), a cellular telephone, or any machine capable of executing a set of instructions (sequential or otherwise) that specify actions to be taken by that machine.

The machine 100 may operate as a standalone device or may be connected (e.g., networked) to other machines. In embodiments where the machine is a standalone device, the set of instructions could be a computer program stored locally on the device that, when executed, causes the device to perform one or more of the methods discussed herein. Consider an example in which the machine 100 is a tablet device, such as an iPad™ or Android™ device; the computer program could be an “app” installed on the tablet device. In embodiments where the computer program is locally stored, data may be retrieved from local storage or from a remote location via a network. In a networked deployment, the machine 100 may operate in the capacity of a server or a client machine in server-client network environment, or as a peer machine in a peer-to-peer (or distributed) network environment. Although only a single machine is illustrated in FIG. 2, the term “machine” shall also be taken to include any collection of machines that individually or jointly execute a set (or multiple sets) of instructions to perform any one or more of the methods discussed herein.

The example machine 100 illustrated in FIG. 2 includes a processor 102 (e.g., a central processing unit (“CPU”)), a memory 104, a video adapter 106 that drives a video display system 108 (e.g., a liquid crystal display (“LCD”) or a cathode ray tube (“CRT”)), an input device 110 (e.g., a keyboard, mouse, touch screen display, etc.) for the user to interact with the program, a disk drive unit 112, and a network interface adapter 114. Note that various embodiments of the machine 100 will not always include all of these peripheral devices.

The disk drive unit 112 includes a computer-readable medium 116 on which is stored one or more sets of computer instructions and data structures embodying or utilized by an auditing tool 118 described herein. The computer instructions and data structures may also reside, completely or at least partially, within the memory 104 and/or within the processor 102 during execution thereof by the machine 100; accordingly, the memory 104 and the processor 102 also constitute computer-readable media. Embodiments are contemplated in which the evaluation tool 118 may be transmitted or received over a network 120 via the network interface device 114 utilizing any one of a number of transfer protocols including but not limited to the hypertext transfer protocol (“HTTP”) and file transfer protocol (“FTP”).

The network 120 may be any type of communication scheme including but not limited to fiber optic, cellular, wired, and/or wireless communication capability in any of a plurality of protocols, such as TCP/IP, Ethernet, WAP, IEEE 802.11, or any other protocol.

While the computer-readable medium 116 shown in the example embodiment of FIG. 2 is a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing a set of instructions for execution by the machine and that cause the machine to perform any one or more of the methods described herein, or that is capable of storing data structures utilized by or associated with such a set of instructions. These instructions may include programming languages, such as the underwriting and rating languages discussed hereinthroughout. The term “computer-readable medium” shall accordingly be taken to include, but not be limited to, solid-state memories, optical media, flash memory, and magnetic media.

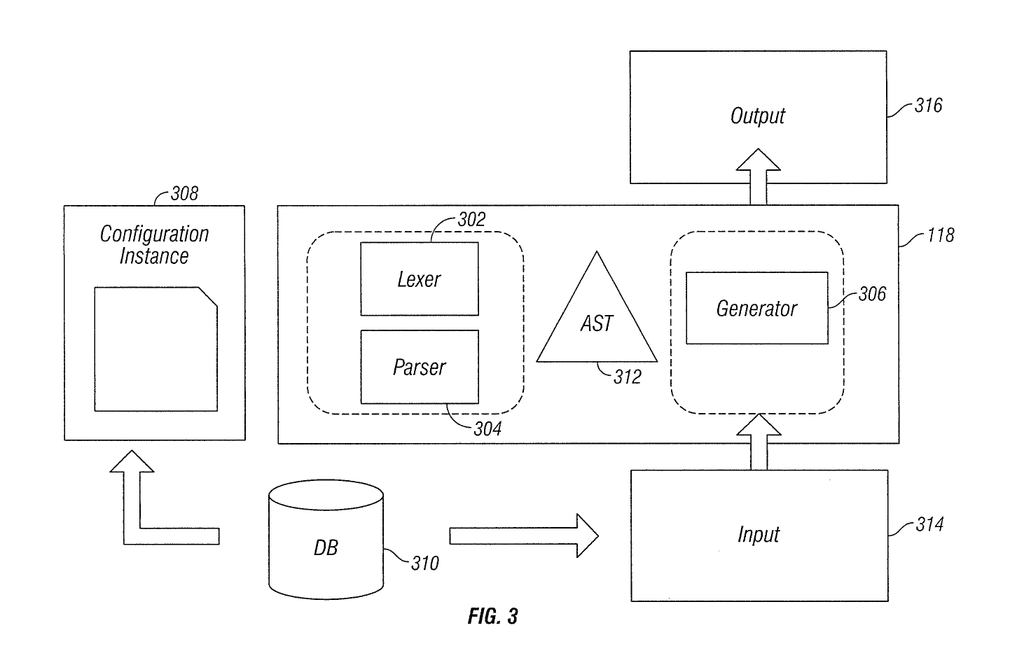

FIG. 3 is an example system architecture that may be used for the evaluation tool 118. In the example shown, the evaluation tool 118 includes a lexer module 302, a parser module 304, and a generator module 306. For the purposes of this specification, the term “module” includes an identifiable portion of computer code, computational or executable instructions, data, or computational object to achieve a particular function, operation, processing, or procedure. A module may be implemented in software, hardware/circuitry, or a combination of software and hardware. An identified module of executable code, for example, may comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Indeed, a module of executable code could be a single instruction, or many instructions, and may even be distributed over several different code segments, among different programs, and across several memory devices. Similarly, modules representing data may be embodied in any suitable form and organized within any suitable type of data structure. The data may be collected as a single data set, or may be distributed over different locations including over different storage devices.

According to embodiments of the disclosure, the lexer module 302 and the parser module 304, in combination, analyze the syntax of an underwriting and rating instance 308. For example, the lexer module 302 may read an input rating instance 308 (such as from a database 310), and recognize tokens such as keywords, operators, and identifiers, among others. The parser module 304 may take the group of tokens output from the lexer module 302, and generate an abstract syntax tree (“AST”) 312. The generator module 306 receives the input data tables 314 (e.g., individual profiles), and generates an output 316 in accordance with the AST 312 and input instances.

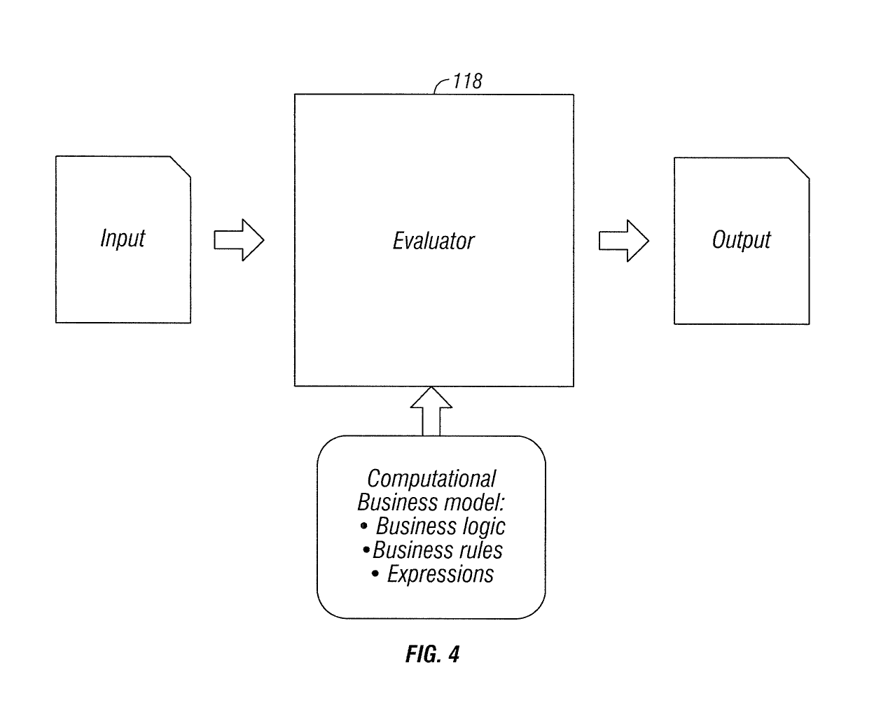

As such, and as shown in a simplified illustration of components of the evaluation tool 118, according to embodiments of the present disclosure in FIG. 4, the evaluation tool receives input data and outputs data in accordance with a computational business model instance including, but not limited to business logic, business rules, and expressions.

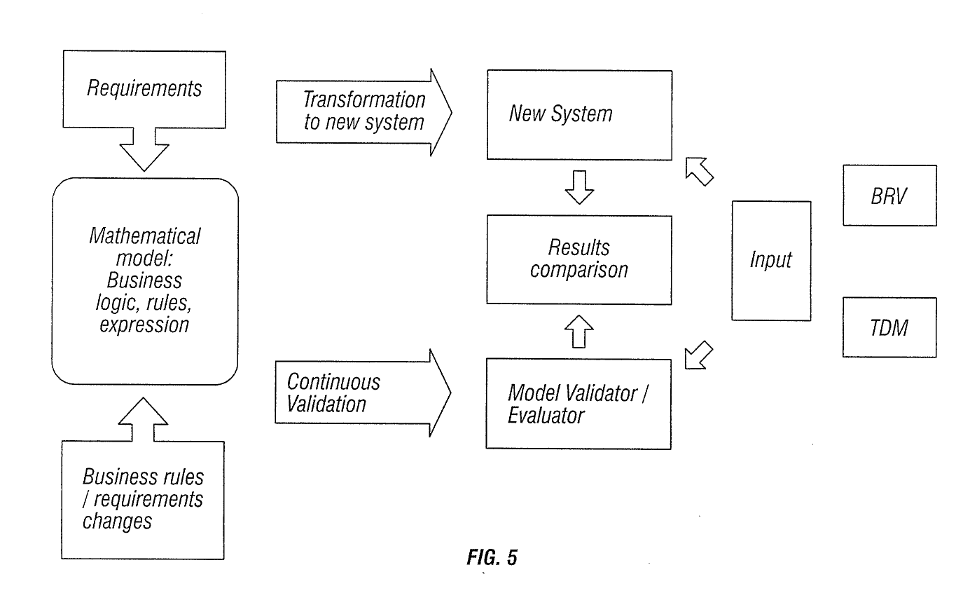

As discussed above, and as illustrated in FIG. 5, the tool 118 may be particularly useful for evaluation (e.g., validation) of a new insurance product prior to, or upon, actual implementation in a policy administration system. For example, new business rules/requirements (“business rules/requirements changes”) 501 with respect to existing requirements 503 may be reflected in the new policy's rating and underwriting instances, which may be represented in a mathematical model 505. These instances may be defined by the above discussed language. A set of input data 507, which may also originate from Business Rules Validation tools (“BRV”) 509 or the Test Data Management systems (“TDM”) 511 may be fed into the evaluation tool 118 as well as the policy administration system (“new system”) 513. After being run through both the new system 513 and the evaluation tool 118, the respective results may be compared 515 to check for any inconsistencies, errors, and the like. Further, through use of the tool, any errors may be easily identified and corrected.

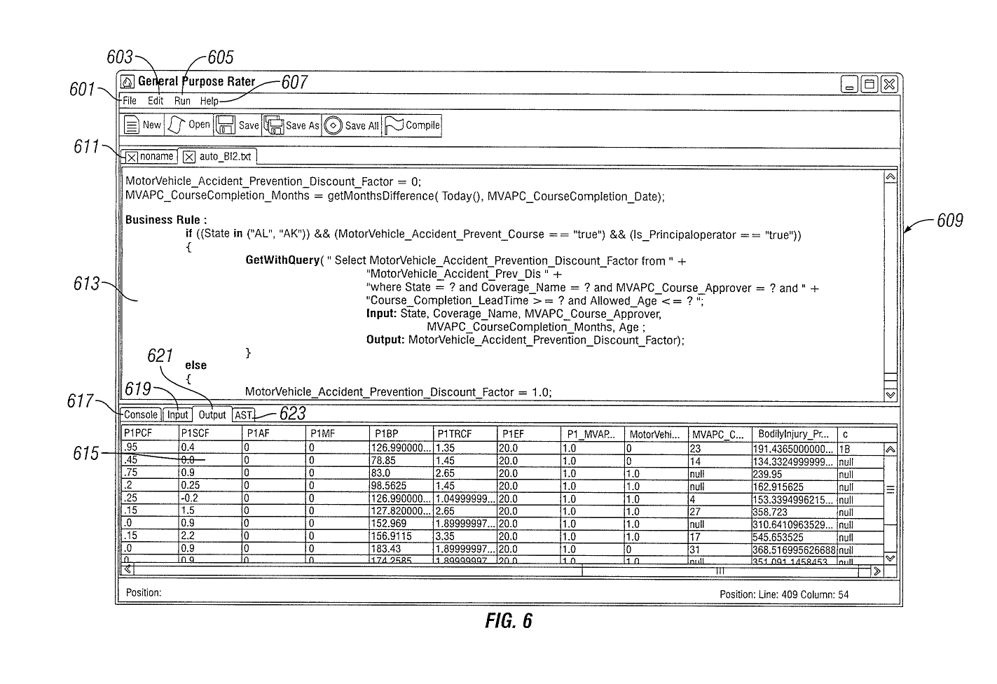

FIG. 6 is an example screenshot of a main page of the evaluation tool 118. Located at the top of the main page are the following menu items: File 601, Edit 603, Run 605, and Help 607. Upon selection, the File menu item 601 allows the user to work on file related activities including, but not limited to: opening/saving a file, creating a new file, saving a file under a new name, save all files, and exit. The Edit menu item 603 allows the user to edit the file. Undo and Redo (not shown) are sub-menu items under the Edit menu item 603. The Run menu item 605 allows for execution of business rules in the file. The Help menu item 607 allows the user, upon selection of “About”, displays details about the product version, vendor, homepage, and support details of the evaluation tool.

Below the menu items, shortcuts are shown allowing the user to perform other activities including, but not limited to the following:
New: To open a new Instance in Edit screen.
Open: A popup window will be opened where the user can navigate and select the previously saved Instances which are in .txt format.
Save: Save the Instance to the preferred location.
Save As: Save a copy of the Instance to the preferred location.
Save All: Save all opened Instances in the Edit screen.
Compile: This will compile the Instance which is currently open in Edit screen.

Below the shortcut menu options is the editor 609. The editor 609 consists of two areas: a list of open files represented by tabs 611, and a file/model viewer 613. When the user clicks on a specific file tab 611, the details of that file will be displayed in the viewer 613. These details include, but are not limited to: input, output, database source, processing type, and the business model with business rules. Further, it is of note that the editor supports syntax coloring. For example, certain keywords may be highlighted in a particular color (e.g., blue). And, the query statements used to take data from a database, for example, may be highlighted in different color (e.g., red) than that of the keywords.

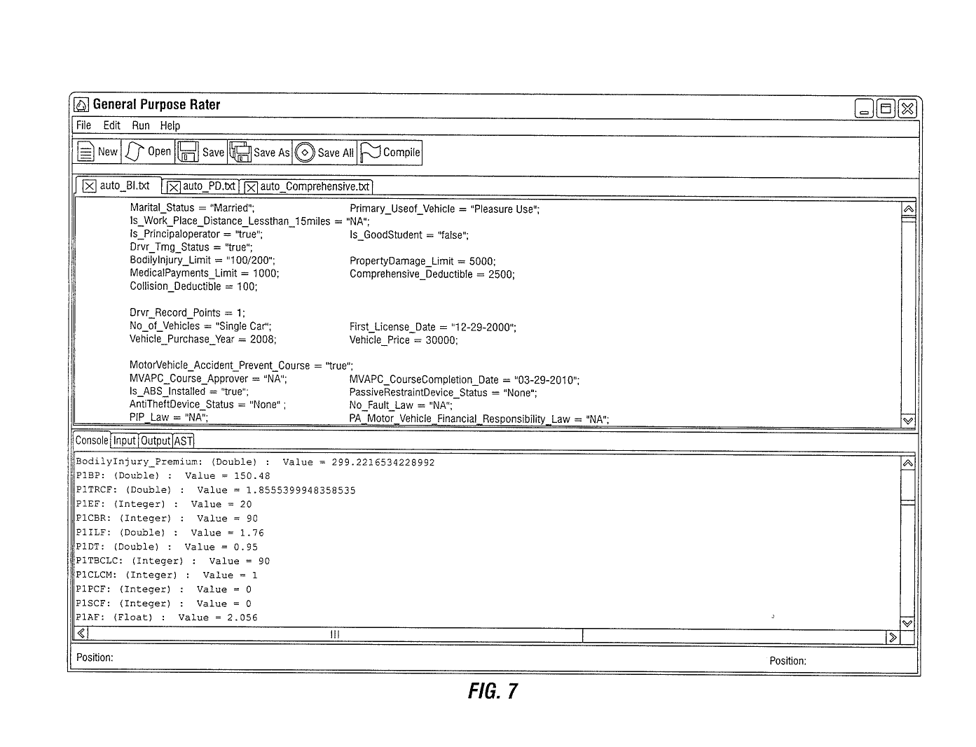

Below the editor 609 is an output window 615 including, but not limited to the following tabs: console 617, input 619, output 621, and AST 623. FIG. 7 is an example screenshot of the console 617. The console 617 acts as a command shell that displays an execution sequence and execution results. For example, and as shown in the example screenshot in FIG. 7, the console 617 displays the output from the instance components and any debugging messages.

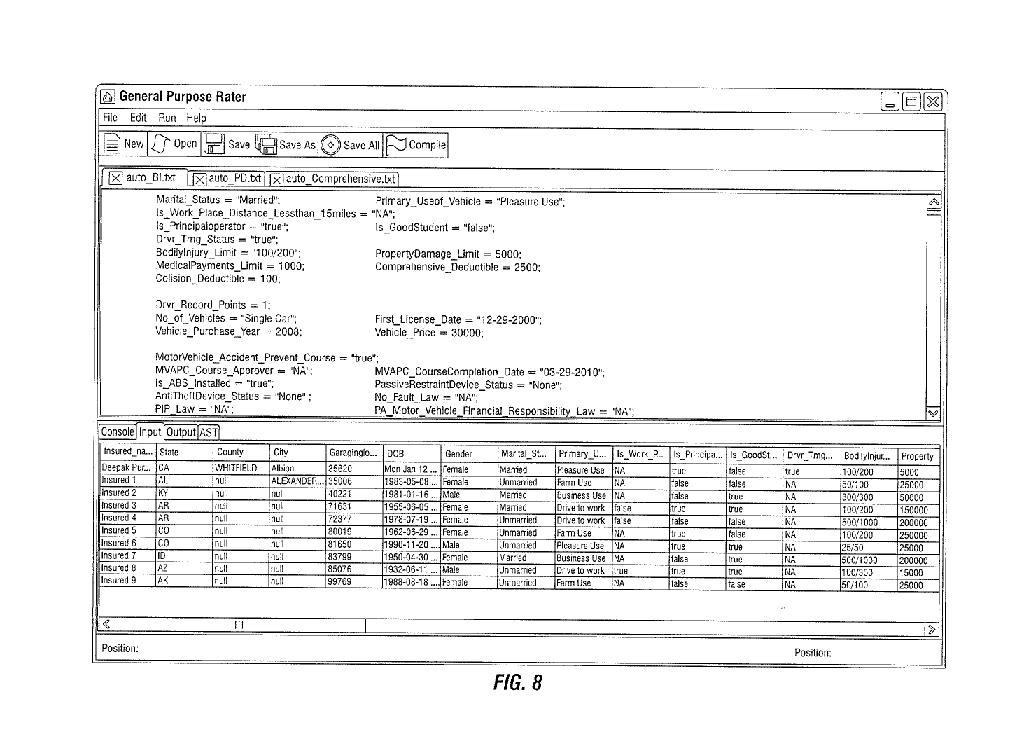

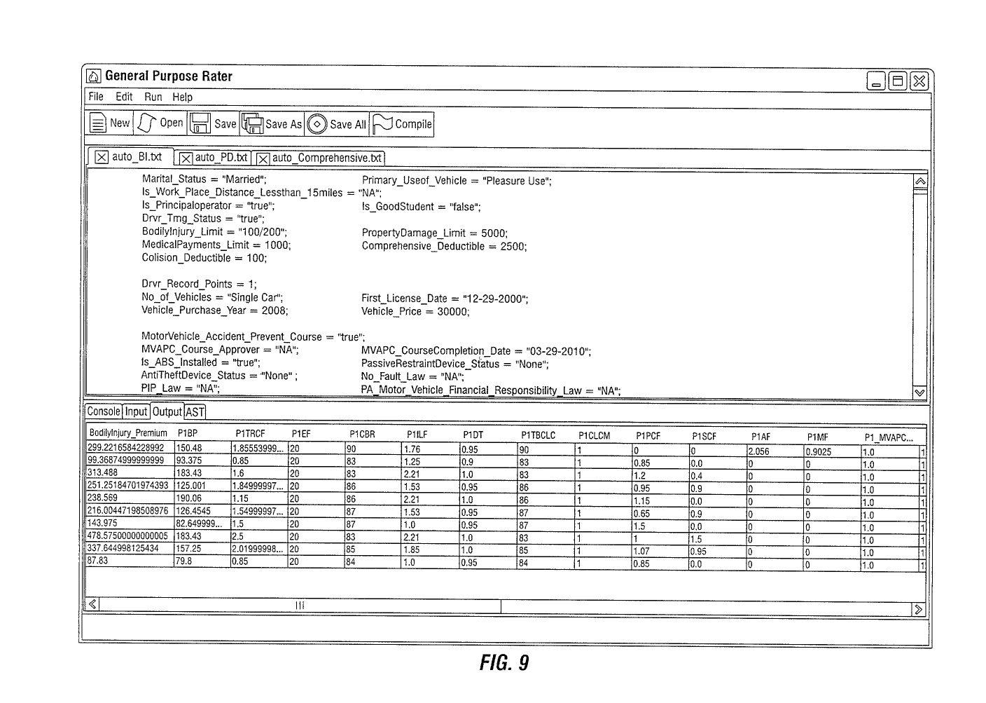

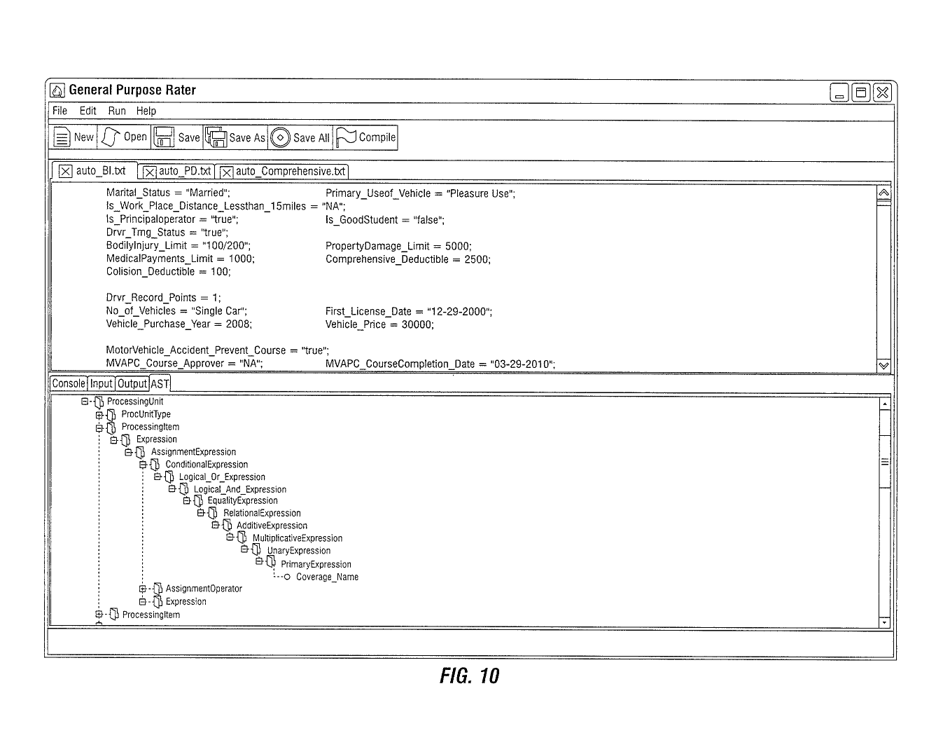

FIG. 8 is an example screenshot upon clicking the input tab 619. As shown, the output window 615 displays all the inputs given to validate the selected instance. Each row is a set of input data. FIG. 9 is an example screenshot upon clicking the output tab 621. As shown, the output window 615 displays the output values corresponding to the respective input rows. FIG. 10 is an example screenshot upon clicking the abstract syntax tree (“AST”) tab 623. As shown, the output window 615 displays an abstract syntax of the instance that was compiled in its tree form.

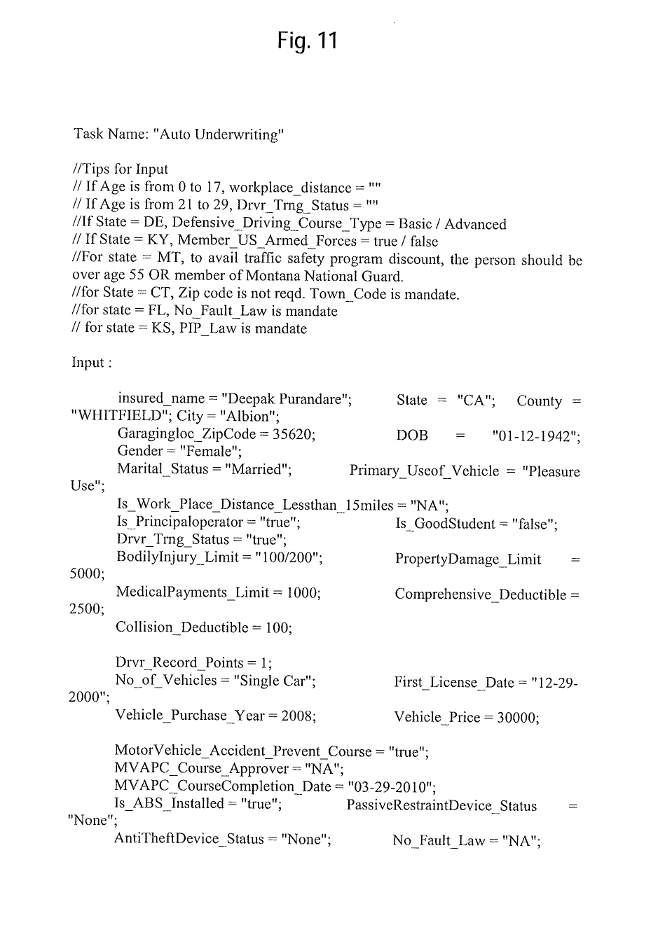

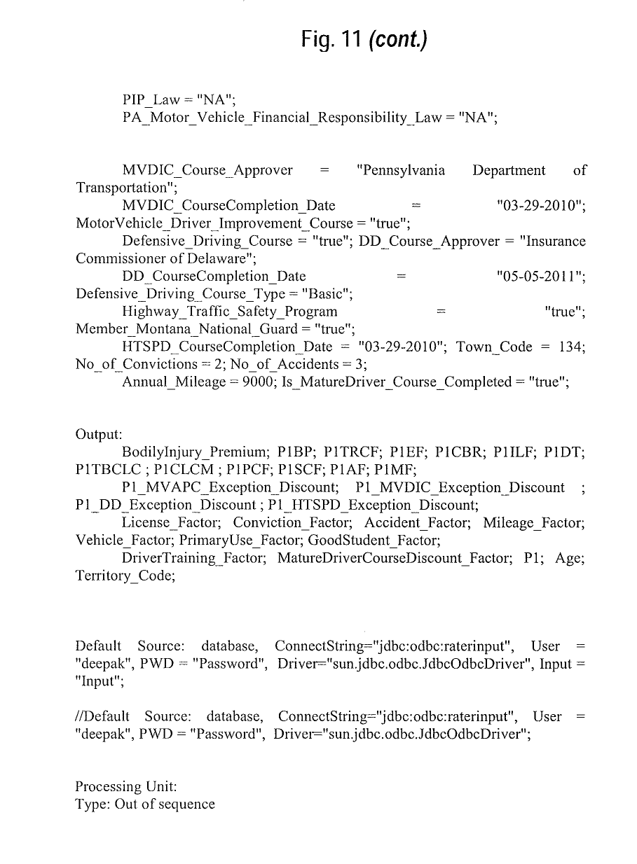

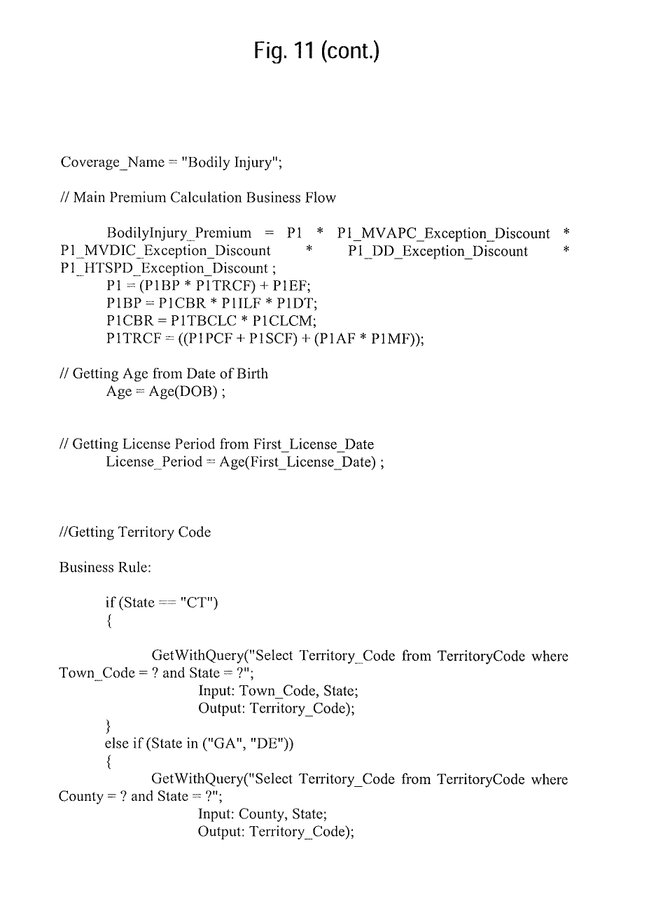

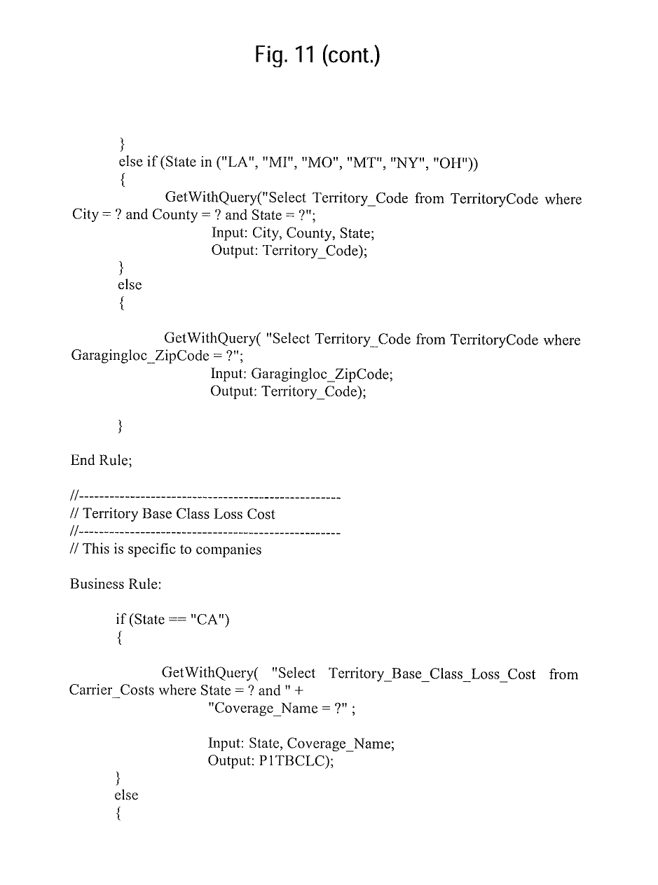

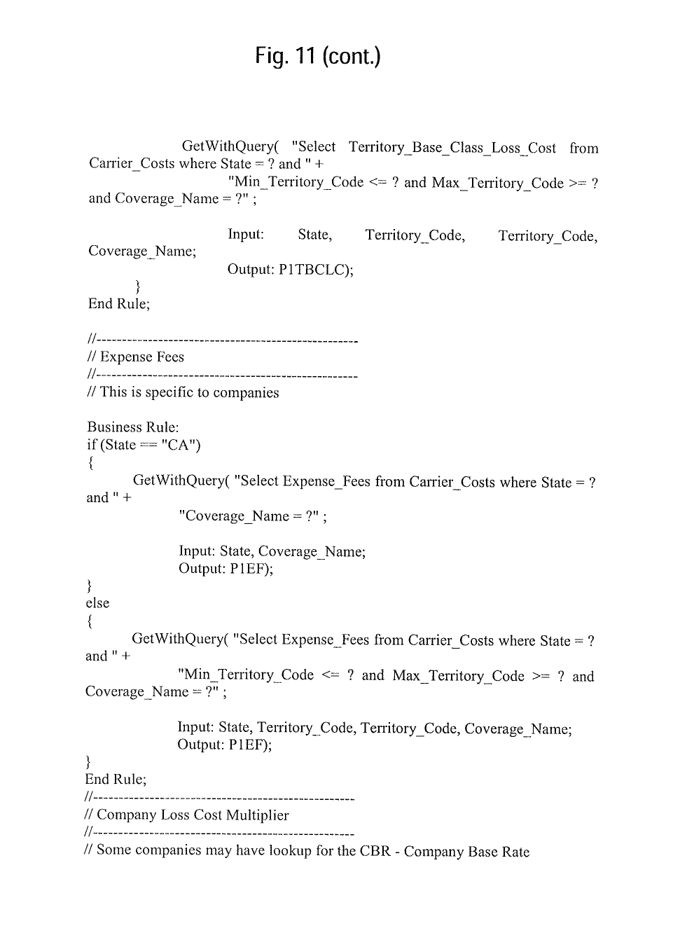

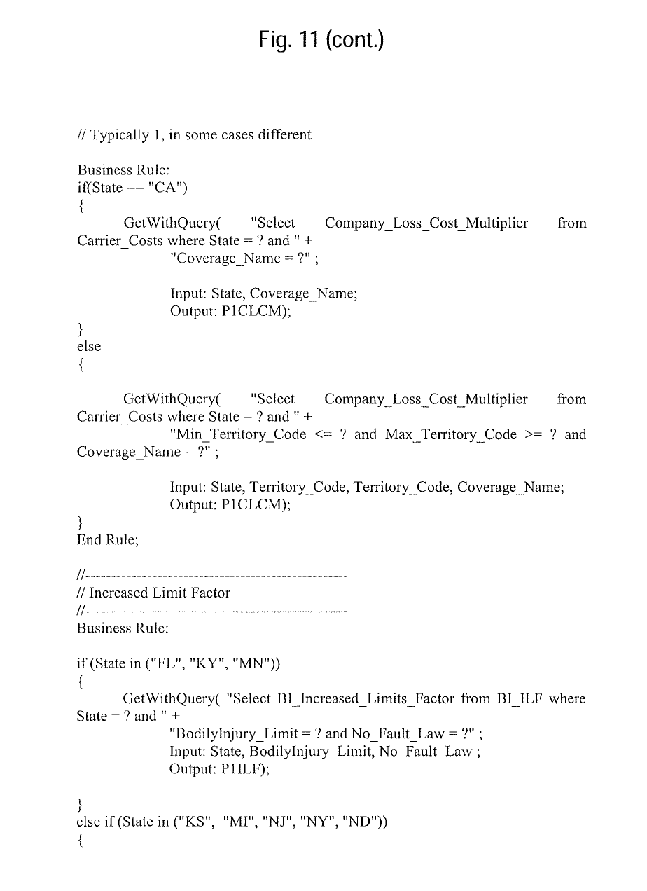

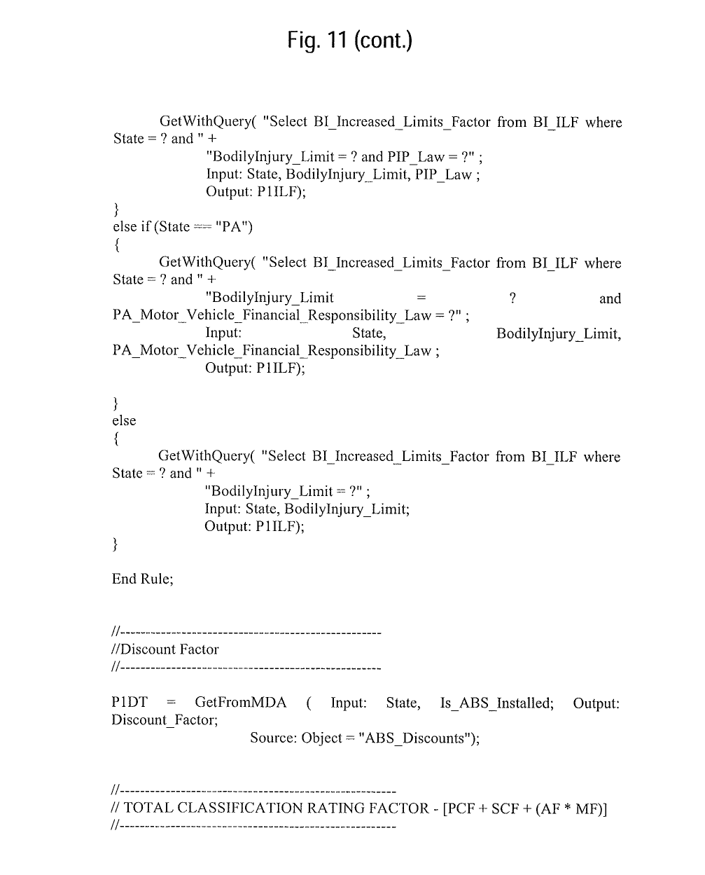

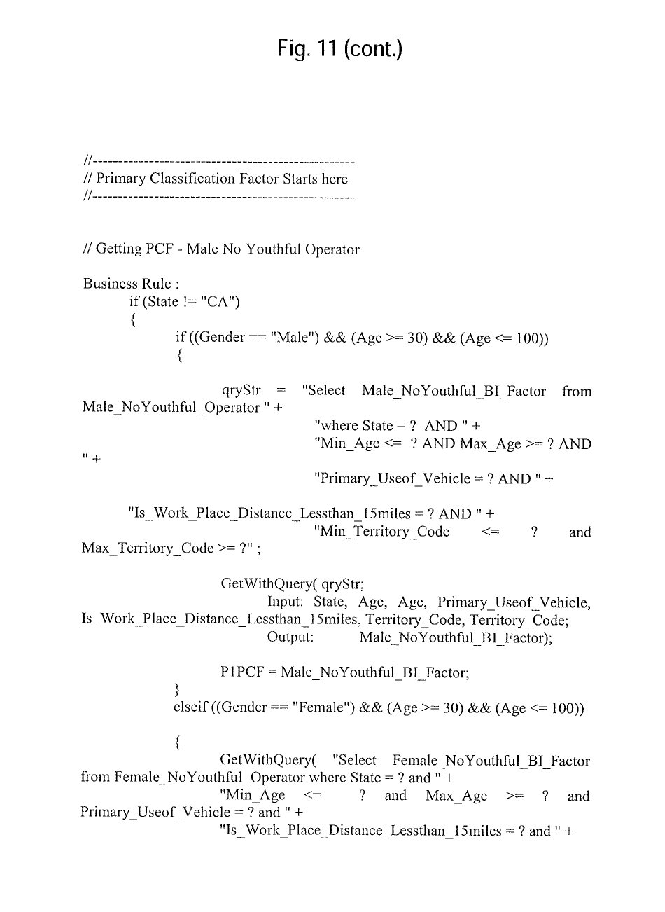

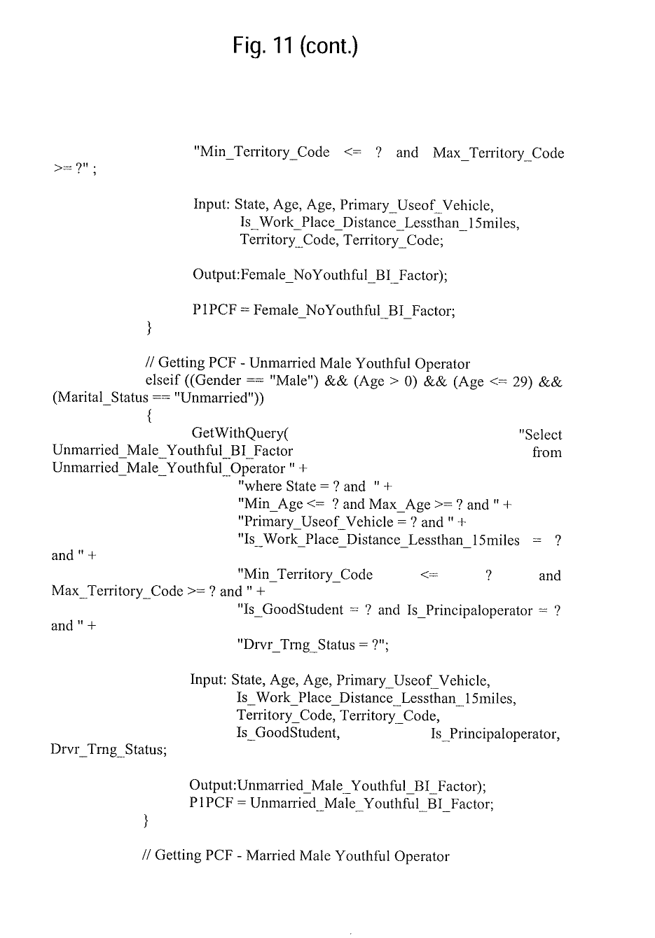

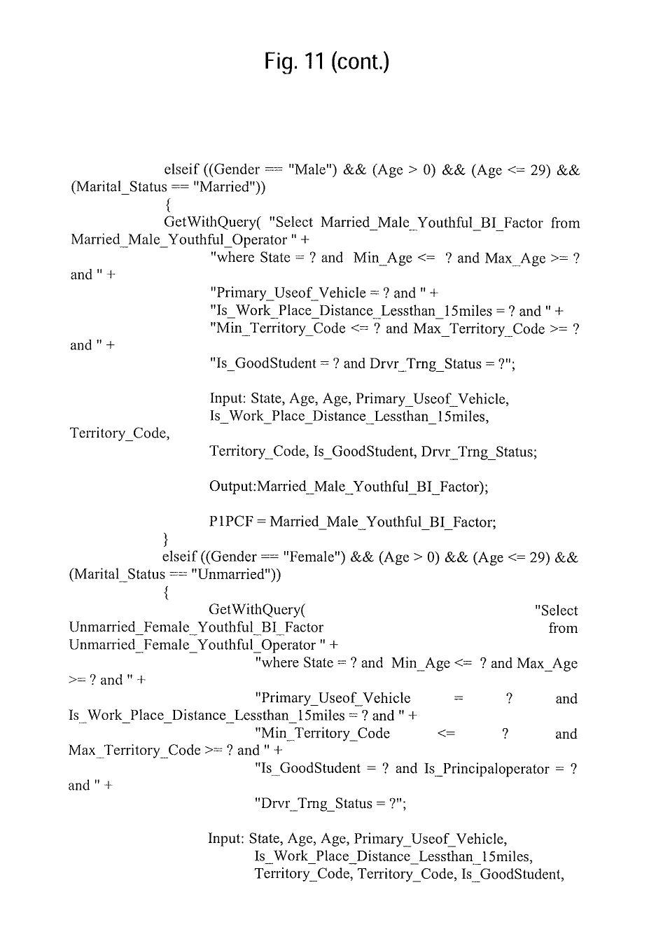

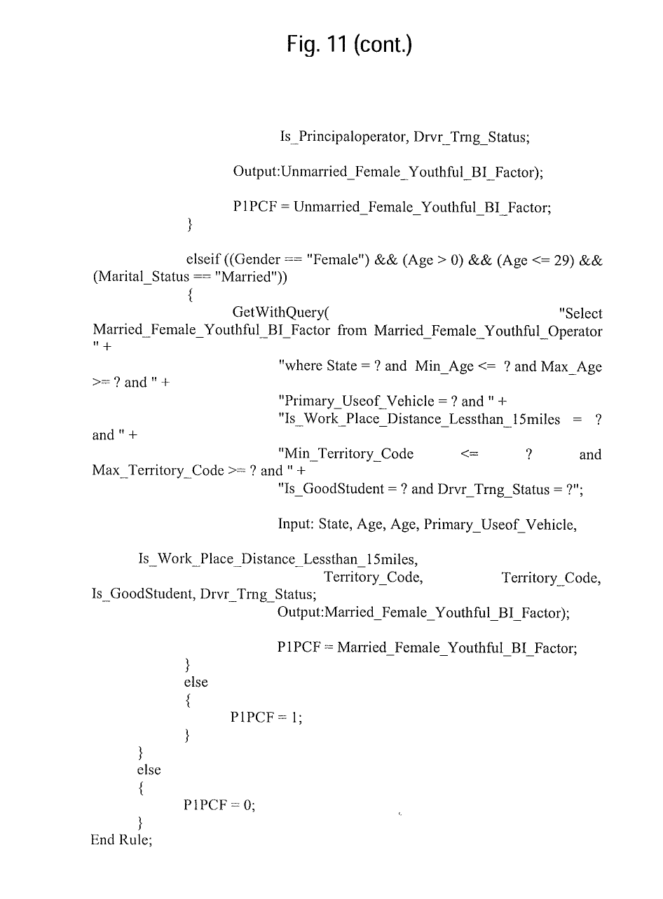

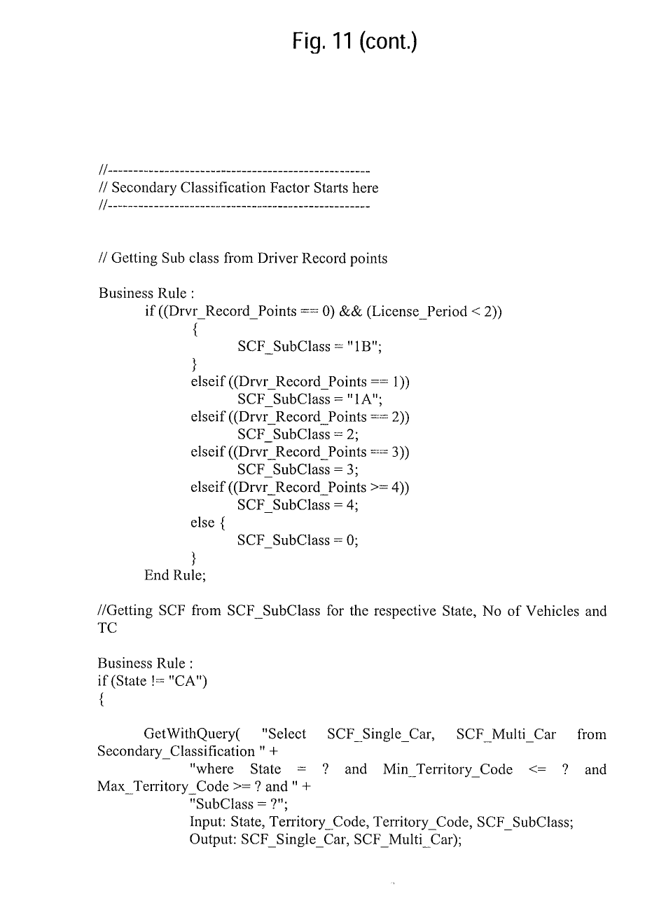

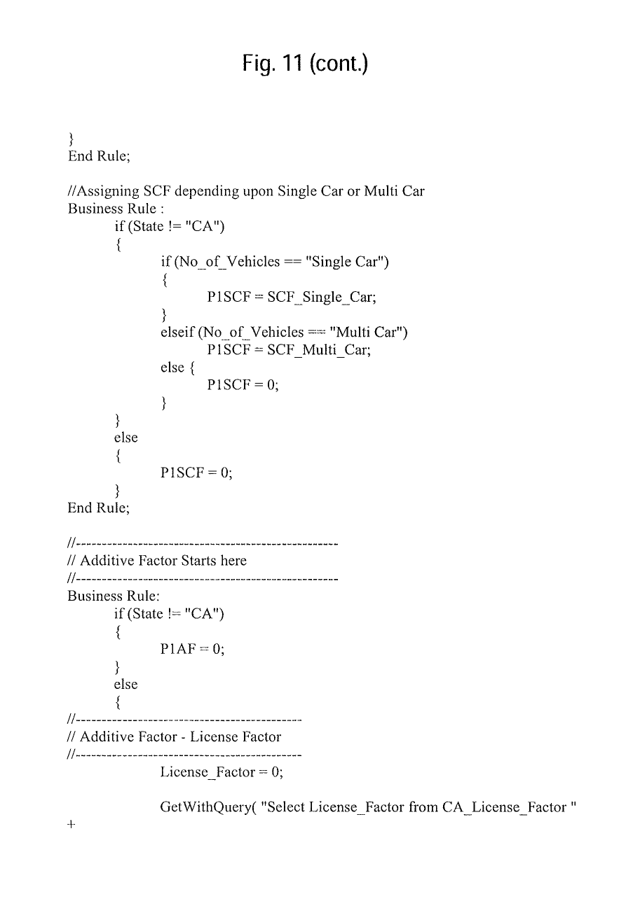

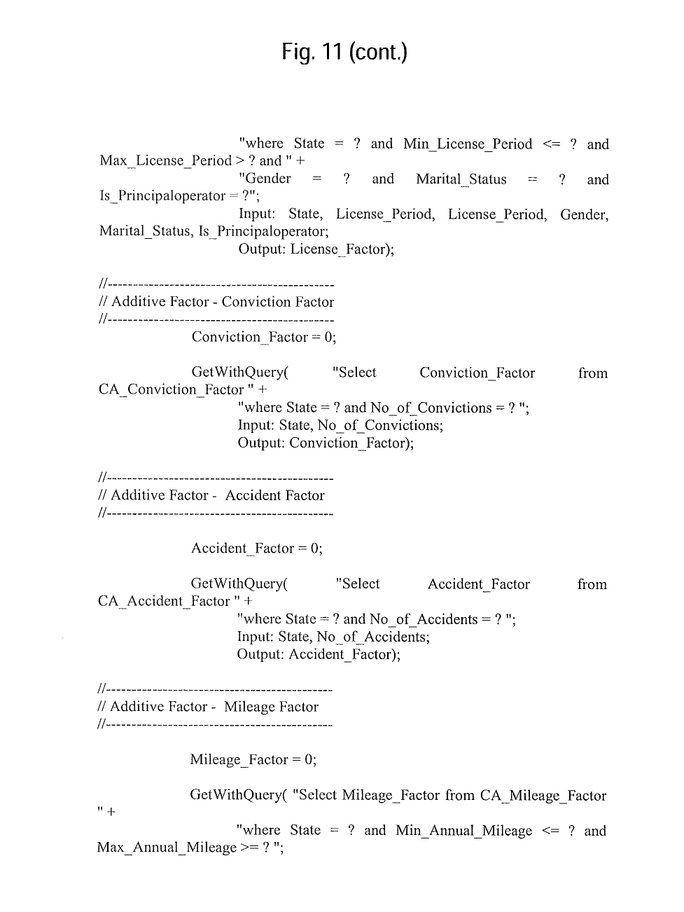

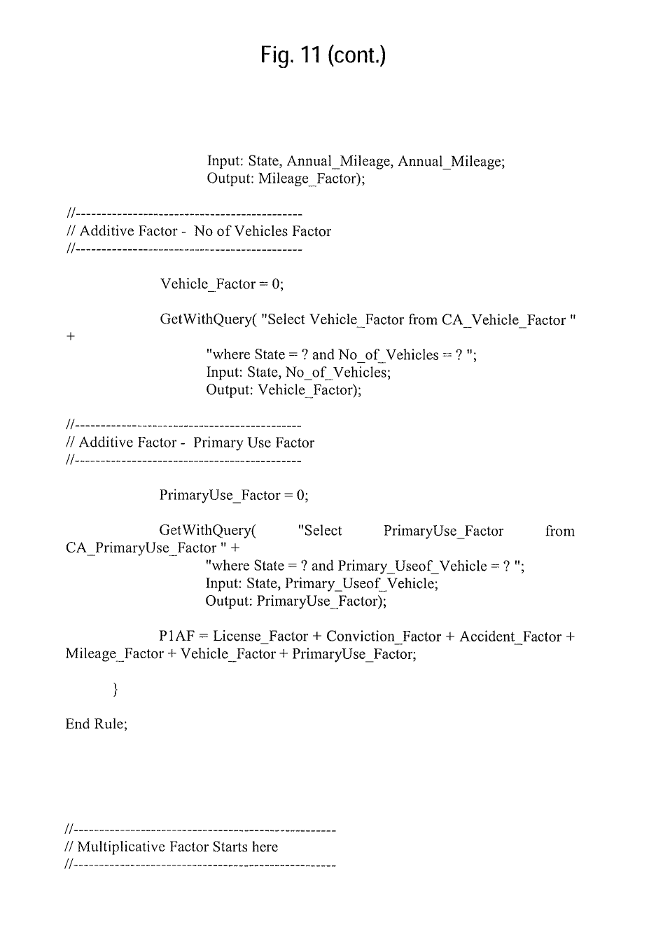

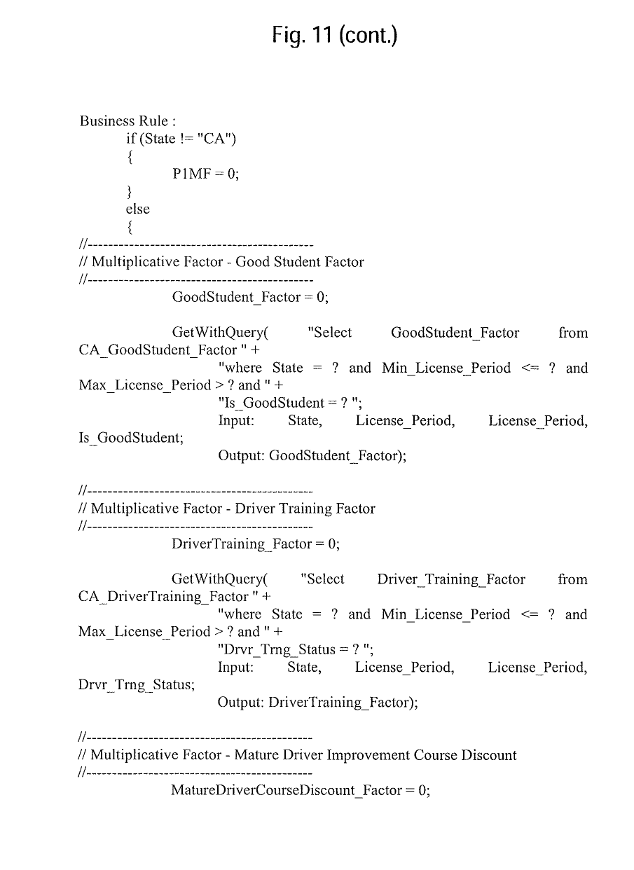

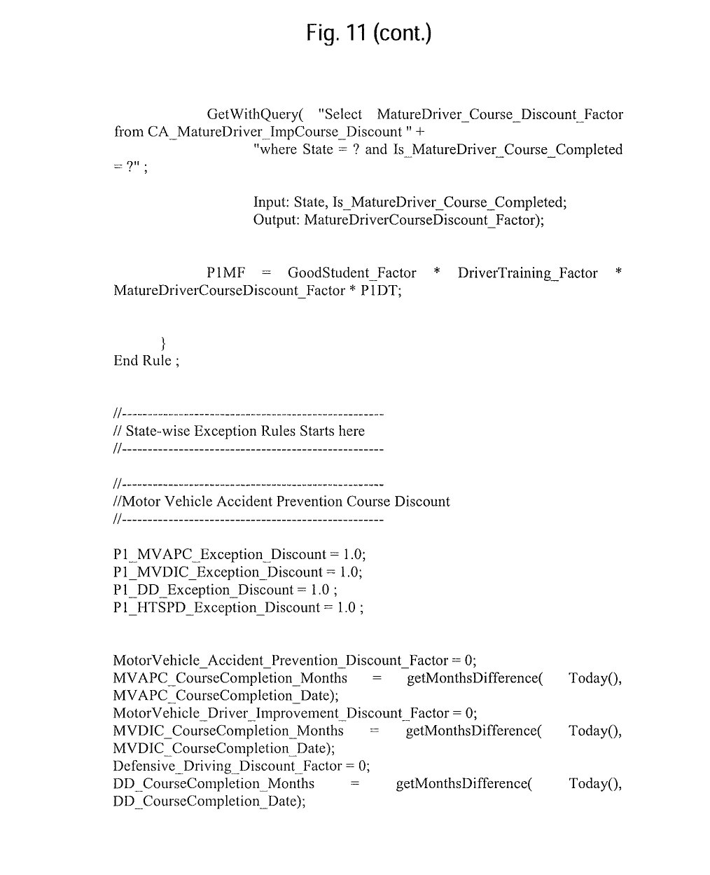

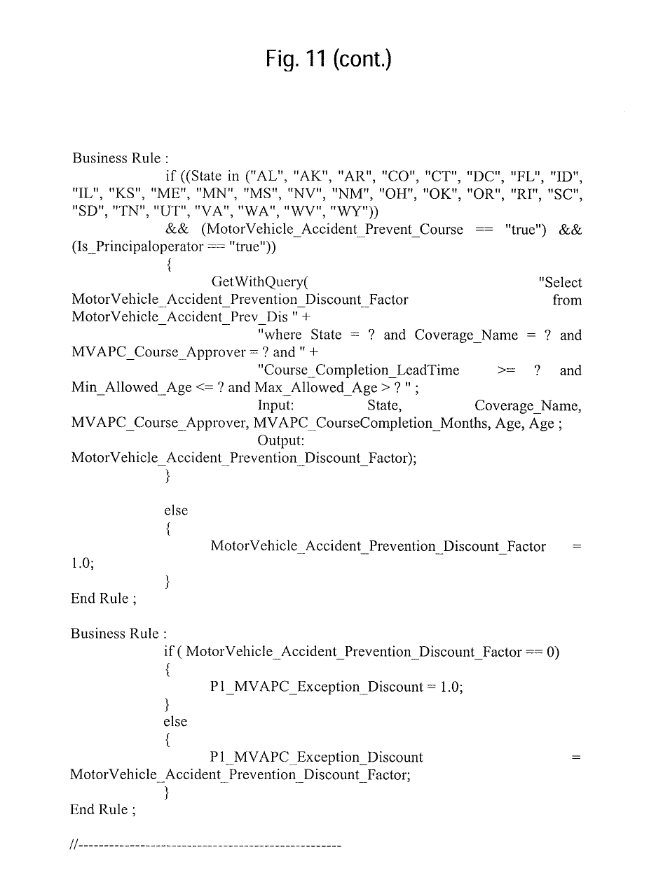

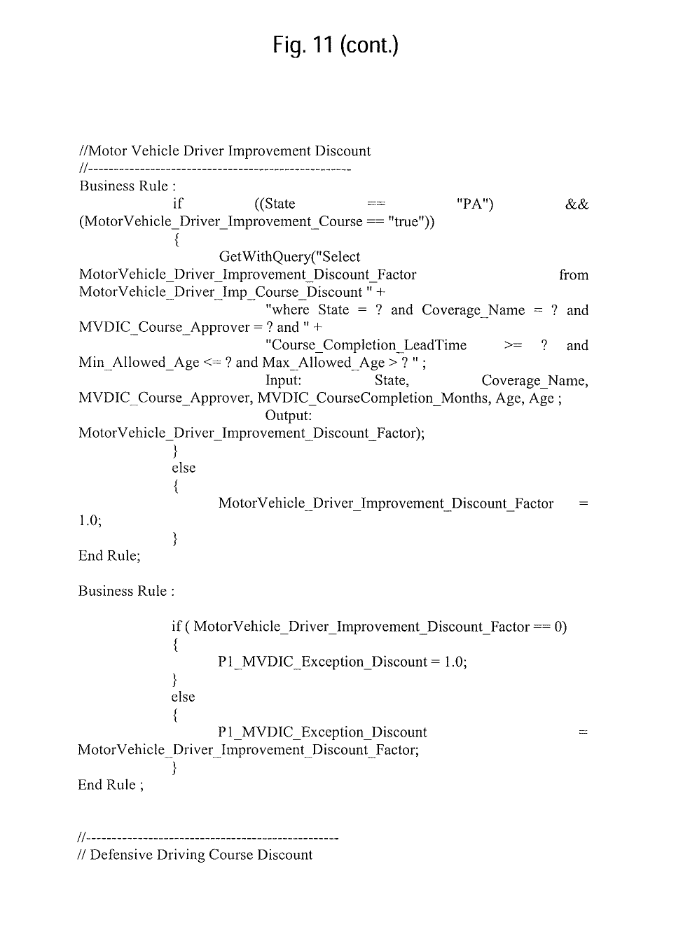

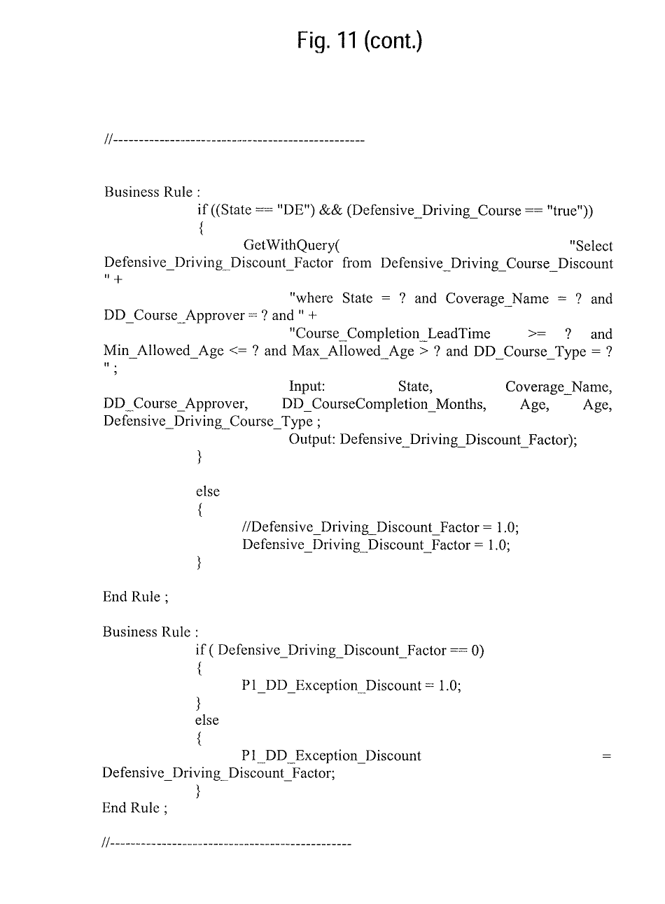

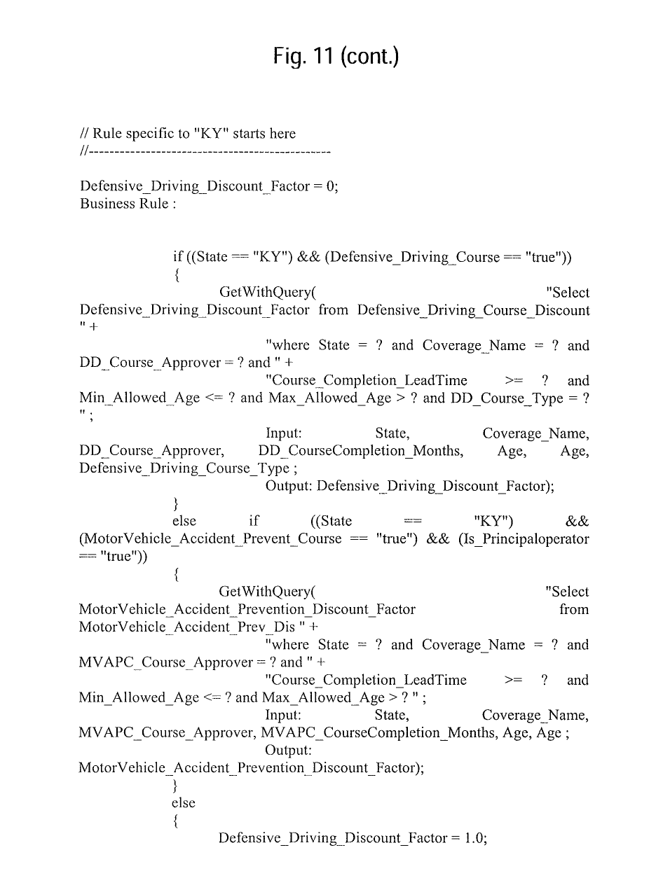

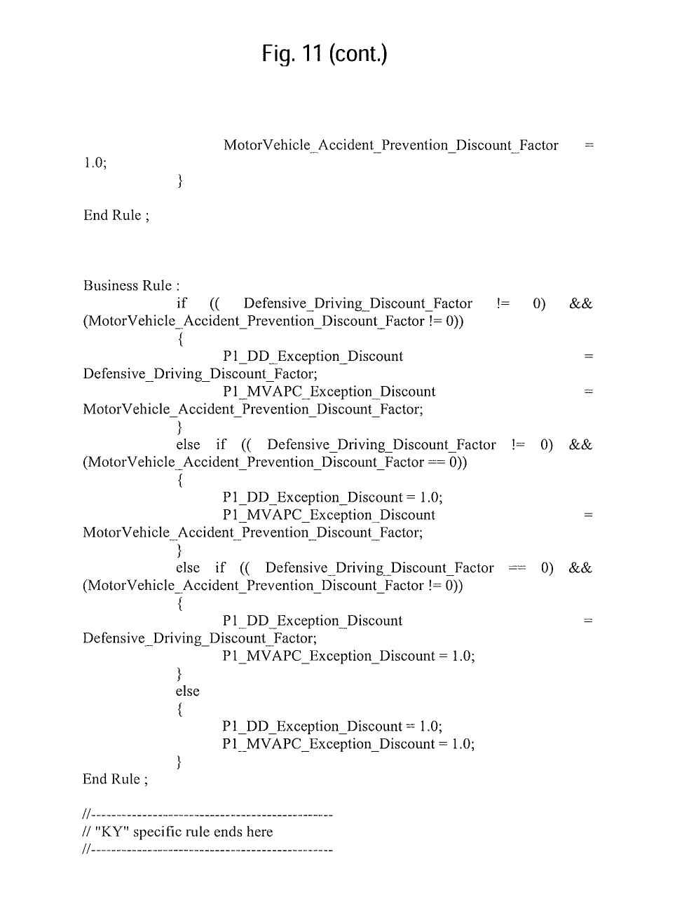

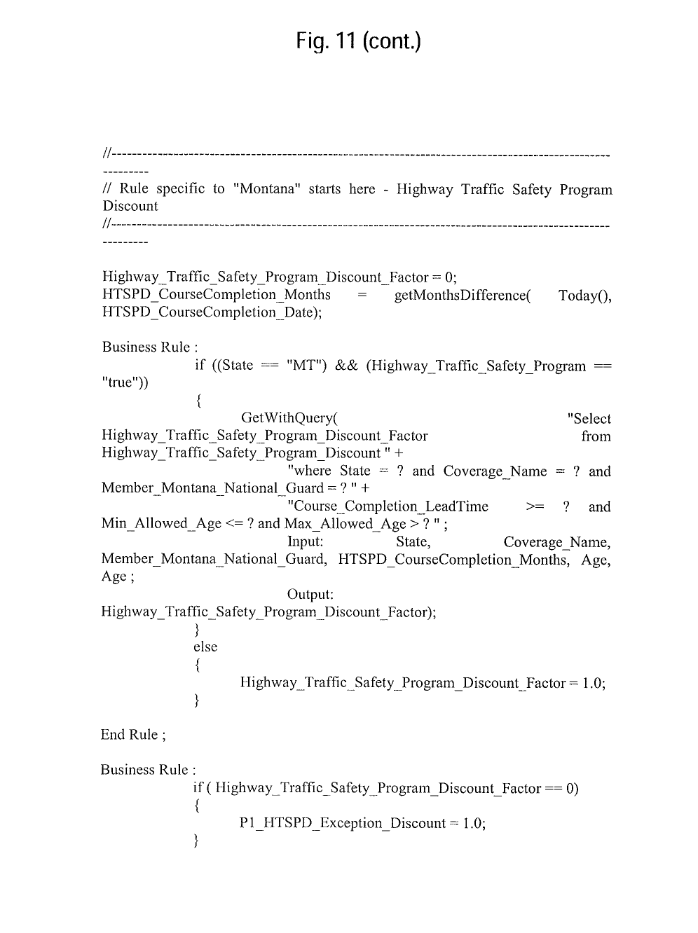

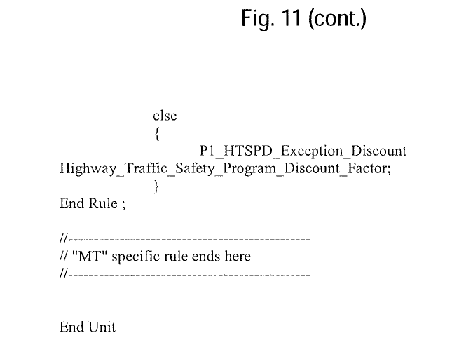

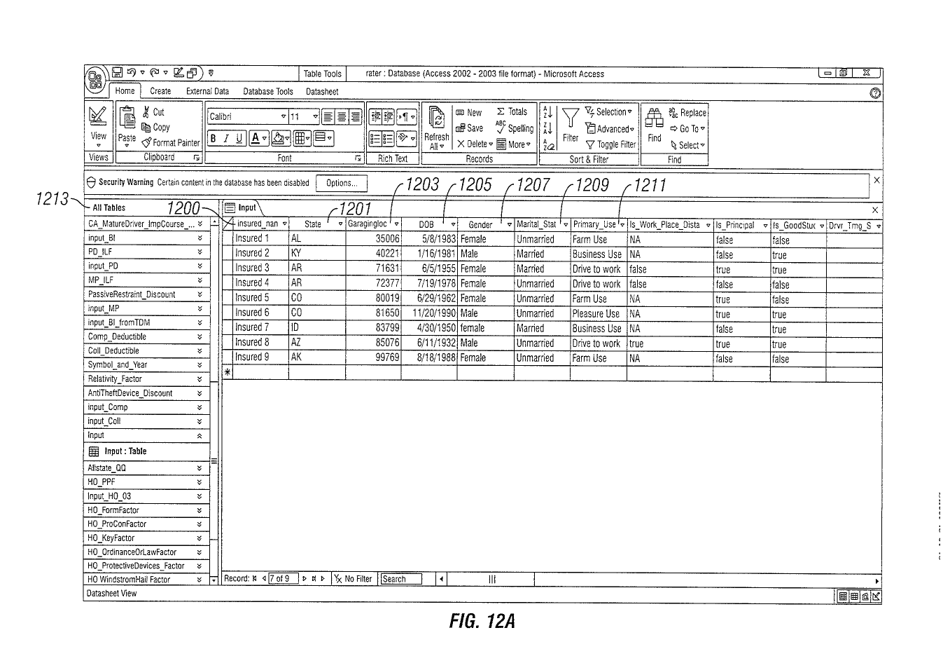

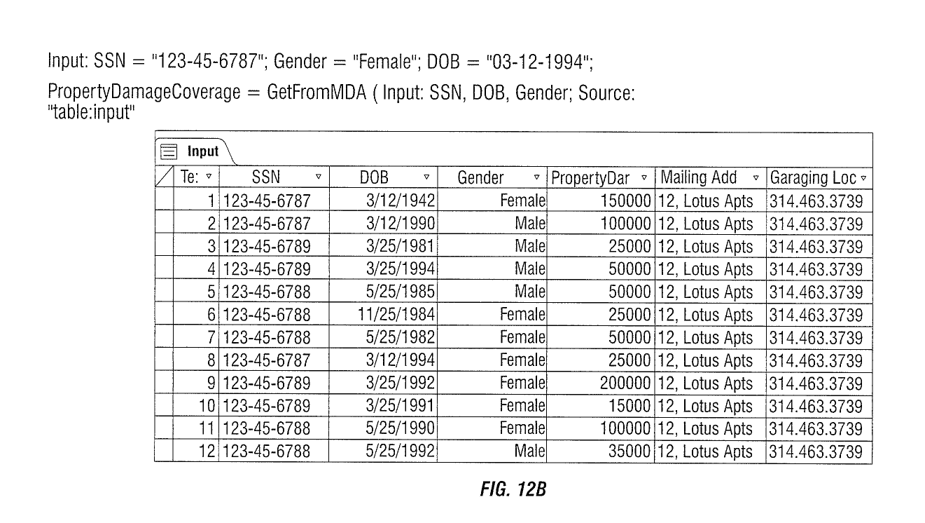

In light of the foregoing, by way of non-limiting example only, the evaluator tool 118 may evaluate an instance (the text of which is shown in FIG. 11) for determining bodily injury coverage for a potentially insured individual. The bodily injury instance retrieves data from various tables, including but not limited to: an input table, an increased limits factor table, a female_noyouthful_operator table, and a state rules table. An example screenshot of the input table is shown in FIGS. 12A and 12B. As shown in FIG. 12A, the input table provides details about insured individuals 1200 (e.g, Insured 1, Insured 2, etc.,) including but not limited to: his or her respective state 1201, zip code 1203, date of birth 1205, gender 1207, marital status 1209, and vehicle's primary use 1211. It should be noted that many other types of data can be retrieved and employed, examples of which are shown in fields in the left hand column under the “all tables” field 1213.

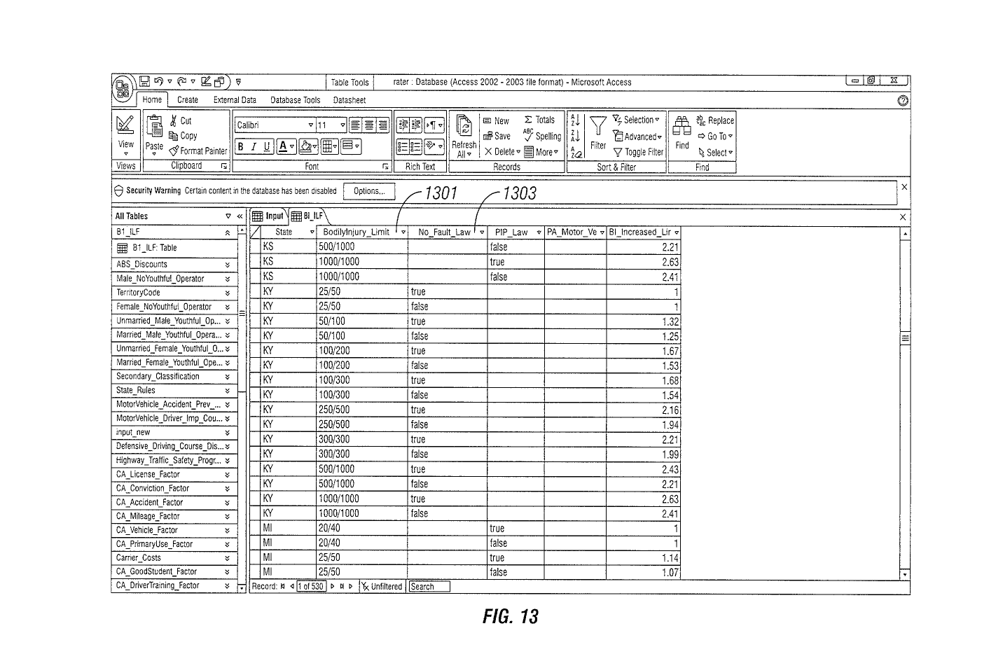

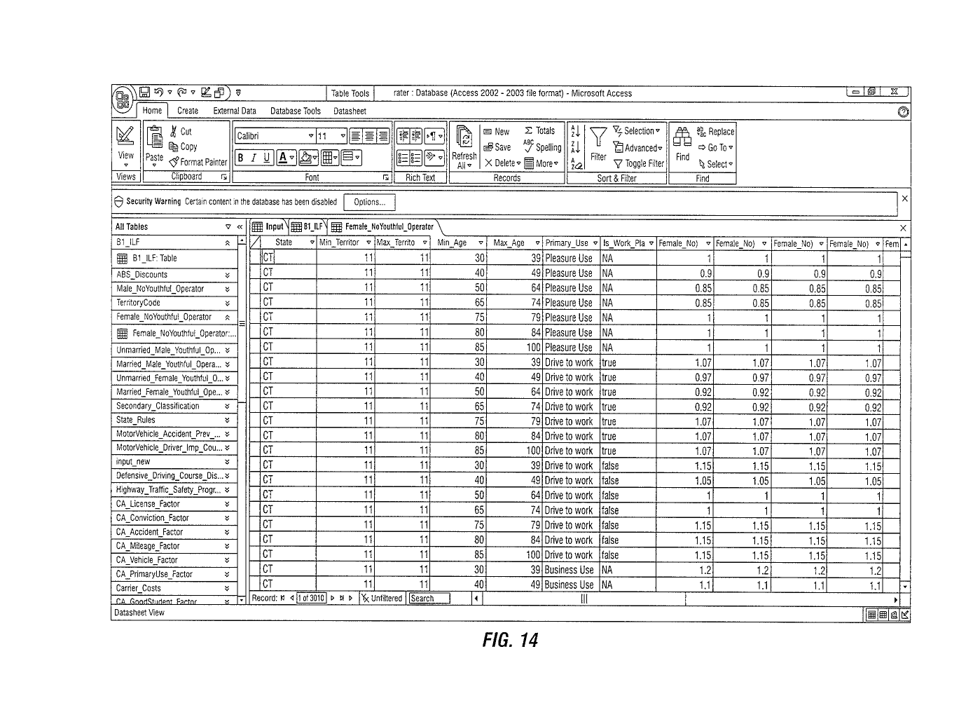

An example screenshot of the increased limits factor table is shown in FIG. 13. As shown, the increased limits factor table provides details about a particular state's bodily injury premium limit 1301, existence of a no fault law 1303, and the like. These details may be used to calculate an increased limits factor. An example screenshot of the female_noyouthful_operator table is shown in FIG. 14. This table displays data used to calculate a primary classification factor. An example screenshot of the state rules table is shown in FIG. 15. This table displays details regarding a particular state's coverages 1501, any state specific discounts 1503, and discount factors 1505.

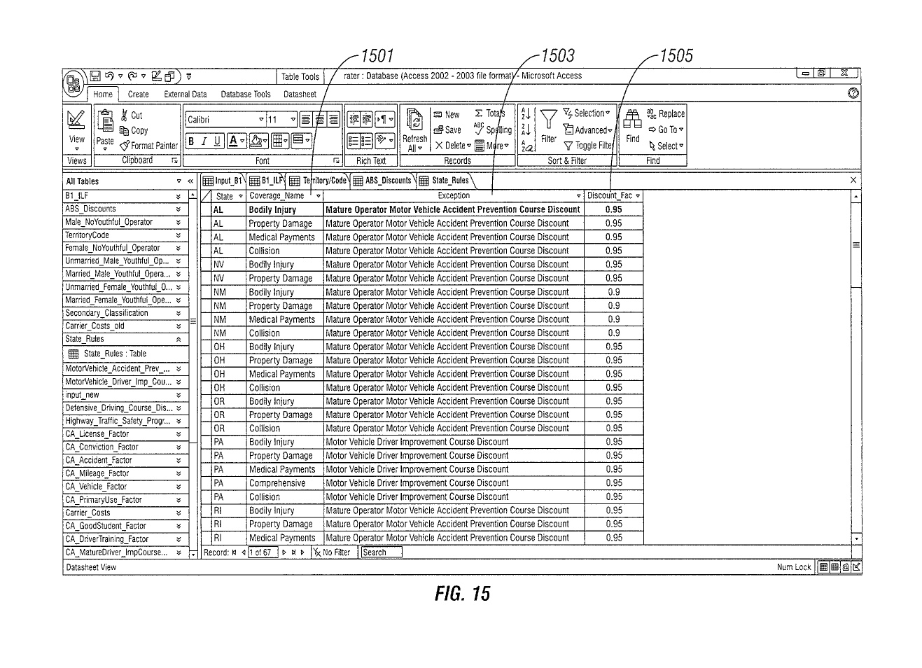

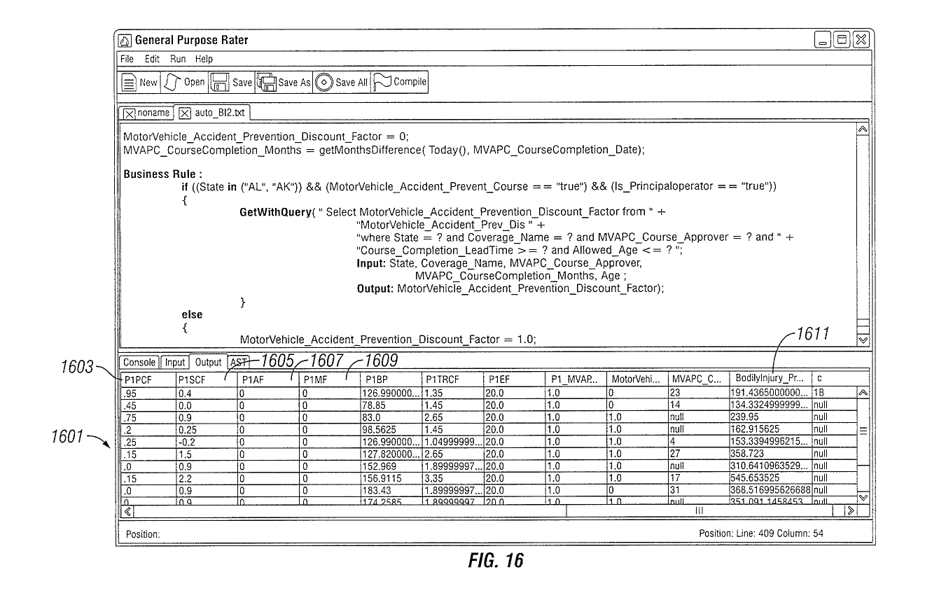

With these data from the above discussed tables, the evaluation tool 118 may evaluate the desired bodily injury coverage instance. FIG. 16 is an example screenshot of the output 1601 generated by the evaluator tool 118. As shown, the output displays information including but not limited to: an insured's primary classification factor 1603, secondary classification factor 1605, Additive factor 1607, Multiplicative factor 1609, and bodily injury premium 1611.

Although the present disclosure has been described with reference to particular means, materials and embodiments, from the foregoing description, one skilled in the art can easily ascertain the essential characteristics of the present disclosure and various changes and modifications may be made to adapt the various uses and characteristics without departing from the spirit and scope of the present invention as set forth in the following claims.

What is claimed is:

1. A computerized system for evaluating an insurance policy underwriting and rating instance, the system comprising:
a lexer module on a computer configured to tokenize the insurance policy instance;
a parser module on a computer configured to parse the tokenized insurance policy instance; and
a generator module on a computer configured to:
receive a profile associated with an insured person; and
evaluate the insurance policy instance by applying the profile to the insurance policy instance.

2. The computerized system of claim 1, wherein the generator module is further configured to graphically display a result of the evaluation; and the result includes a simulated premium to be paid by the insured person.

3. The computerized system of claim 2, wherein the result is compared to a second result generated by the application of the insurance policy instance implemented in a policy administration system.

4. The computerized system of claim 1, wherein the insurance policy instance is defined in a top-down sequence.

5. The computerized system of claim 1, wherein the insurance policy instance is defined using at least one parameter configured to retrieve data from a multi-dimensional array.

6. The computerized system of claim 5, wherein the insurance policy instance includes at least one business rule applied to the retrieved data from the multi-dimensional array.

7. The computerized system of claim 1, wherein the generator module is further configured to identify an error in the insurance policy instance.

8. A computerized system for evaluating an insurance policy instance, the system comprising:
one or more computing devices including:
a memory having program code stored therein;
a processor in communication with the memory configured to carry out instructions in accordance with the stored program code, wherein the program code, when executed by the processor, causes the processor to perform operations comprising:
analyzing a syntax of the insurance policy underwriting instance;
receiving a profile associated with an insured person; and
evaluating the insurance policy instance by applying the profile to the analyzed insurance policy instance; and
graphically displaying a result of the evaluation, wherein the result includes a premium to be paid by the insured person.

9. The computerized system of claim 8, wherein the result is compared to a second result generated by the application of the profile to the insurance policy instance to the profile already implemented in a policy administration system.

10. The computerized system of claim 8, wherein the insurance policy instance is defined in a top-down sequence.

11. The computerized system of claim 8, wherein the insurance policy instance is defined using at least one parameter configured to retrieve data from a multi-dimensional array.

12. The computerized system of claim 11, wherein the insurance policy instance includes at least one business rule applied to the retrieved data from the multi-dimensional array.

13. The computerized system of claim 8, wherein the generator module is further configured to identify an error in the insurance policy instance.

14. The computerized system of claim 8, further comprising displaying an abstract syntax tree representing the policy insurance instance.

15. A computerized system for evaluating an insurance policy instance, the
a lexer module on a computer configured to tokenize the insurance policy underwriting instance;
a parser module on a computer configured to parse the tokenized insurance policy underwriting instance;
a generator module on a computer configured to:
receive a profile associated with an insured person;
evaluate the insurance policy instance by applying the profile to the insurance policy instance; and
graphically display a result of the evaluation, wherein the result includes a premium to be paid by the insured person.

16. The computerized system of claim 15, wherein the result is compared to a second result generated by the application of the profile to the insurance policy instance to the profile already implemented in a policy administration system.

17. The computerized system of claim 15, wherein the insurance policy instance is defined in a top-down sequence.

18. The computerized system of claim 15, wherein the insurance policy instance is defined using at least one parameter configured to retrieve data from a multi-dimensional array.

19. The computerized system of claim 15, wherein the generator module is further configured to identify an error in the insurance policy instance.

20. The computerized system of claim 15, wherein the insurance policy instance is associated with an automobile policy.
